(19) United States
(12) Patent Application Publication
(10) Pub. No.: US 2011/0022197 A1
(43) Pub. Date: Jan. 27, 2011

(54) PROCESS CONTROL APPLICATION DEVELOPMENT ENVIRONMENT AND FEATURES

(75) Inventor: Urban Robert Kultgen, II, Silver Bow, MT (US)

Correspondence Address: KLARQUIST SPARKMAN, LLP, 121 SW SALMON STREET, SUITE 1600, PORTLAND, OR, 97204, US

(73) Assignee: REC Advanced Silicon Materials LLC, Moses Lake, WA (US)

(21) Appl. No.: 12/843,719

(22) Filed: Jul. 26, 2010

Related U.S. Application Data
(60) Provisional application No. 61/228,904, filed on Jul. 27, 2009.

(51) Int. Cl. G05B 19/04; G06F 9/54

(52) U.S. Cl. 700/86; 719/317

(57) ABSTRACT

A process control application development environment provides an abstraction layer for vendor-independent process control application development. Various features such as validation of high-level representations of process control applications, exception handler agents, structured interactive operation of multiple machines, and multiple device states can be implemented for process control applications.

### CROSS REFERENCE TO RELATED APPLICATION

This application claims the benefit of U.S. Provisional Patent Application No. 61/228,904, filed on Jul. 27, 2009, entitled “PROCESS CONTROL APPLICATION DEVELOPMENT ENVIRONMENT AND FEATURES,” which is hereby incorporated herein by reference.

### BACKGROUND

Process control has become an indispensible technology in manufacturing, chemical, petroleum, and other processes. Although originally a simple technology, process control has evolved to be a complex discipline.

Although existing process control technologies are useful, there are various limitations.

### SUMMARY

A variety of technologies are helpful for developing and implementing process control applications.

Validation for a high-level process control application can be performed. For example, a validation rule set can be associated with a high-level representation of a process control application. Association can be achieved by using machine classes for high-level representations of process control applications. When a new application using the machine class is created, it can be associated with the rule set already associated with the class.

Exception handler agents can be implemented to handle a variety of exception handling scenarios. Agents can be configured at runtime if desired.

Communication between multiple machines can be implemented to achieve process synchronization and machine encapsulation.

Multiple device state sets can be stored by the high-level representation of the process control application. The high-level representation can include a directive that indicates that a different set of field device state patterns is to be used. For example, instructions in the high-level representation can be re-used by applying a different set of device state patterns for the re-used instructions.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary process control system.

FIG. 2 is a block diagram of an exemplary method of implementing process control.

FIG. 3 is a block diagram of an exemplary process control system data structure for representing a process control application.

FIG. 4 is a block diagram of an exemplary method of executing a process control application.

FIG. 5 is a block diagram of an exemplary system for performing validation of a high-level representation of a process control application.

FIG. 6 is a flowchart of an exemplary method of performing validation of a high-level representation of a process control application.

FIG. 7 is block diagram of an exemplary system for associating high-level representations with validation rules.

FIG. 8 is a flowchart of an exemplary method of associating a high-level representation to a rule set and identifying which rule set is to be used when validating a high-level representation of a process control application.

FIG. 9 is a flowchart of an exemplary method of validating a high-level representation of a process control application.

FIG. 10 is a flowchart of another exemplary method of validating a high-level representation of a process control application.

FIG. 11 is a block diagram of an exemplary data structure for indicating validation status of a high-level representation of a process control application.

FIG. 12 is a flowchart of an exemplary method of enforcing validation during development of a high-level representation of a process control application.

FIG. 13 is a flowchart of an exemplary method of downloading an application to a controller while enforcing validation of a high-level representation of a process control application.

FIG. 14 is a block diagram of an exemplary system for associating high-level representations of process control applications with validation rule sets using a class mechanism.

FIG. 15 is a block diagram of an exemplary data structure for associating high-level representations of process control applications with validation rule sets using a class mechanism.

FIG. 16 is a flowchart of an exemplary method of performing validation for a high-level representation of a process control application according to a machine class.

FIG. 17 is a block diagram of an exemplary system for invoking exception handler agents in a high-level representation of a process control application.

FIG. 18 is a flowchart of an exemplary method of implementing exception handler agents in a process control application.

FIG. 19 is a block diagram of an exemplary system for implementing activating exception handler agents in a high-level representation of a process control application.

FIG. 20 is a flowchart of an exemplary method of configuring whether an exception handler agent is active.

FIG. 21 is a flowchart of an exemplary method of implementing exception handler agent activation.

FIG. 22 is a screen shot of an exemplary user interface for receiving a user indication of whether an exception handler agent is active.

FIG. 23 is a block diagram of an exemplary system for implementing runtime exception handler agent configuration in a process control application via a high-level representation of the application.

FIG. 24 is a flowchart of an exemplary method of implementing runtime exception handler agent configuration in a process control application.

FIG. 25 is a block diagram of an exemplary encapsulated machine for a high-level representation of a process control application.

FIG. 26 is a block diagram of an exemplary system implementing multiple encapsulated machines for respective high-level representations of process control applications.

FIG. 27 is a flowchart of an exemplary method for implementing multiple encapsulated machines.

FIGS. 28A-D are illustrations of exemplary machine-to-machine communication scenarios.

FIG. 29 is an exemplary synchronization exchange for implementing synchronization between encapsulated machines.

FIG. 30 is an flowchart of an exemplary method for implementing synchronization between encapsulated machines.

FIG. 31 is a block diagram of an exemplary system for using multiple device states for instructions in a high-level representation of a process control application for a process control process.

FIG. 32 is a flowchart of an exemplary method for using multiple device states for instructions in a high-level representation of a process control application.

FIG. 33 is a block diagram of an exemplary system for storing multiple device states for instructions in a high-level representation of a process control application.

FIG. 34 is a block diagram of an exemplary suitable computing environment for implementing any of the technologies described herein.

### DETAILED DESCRIPTION

### Example 1

### Exemplary Process Control Technology

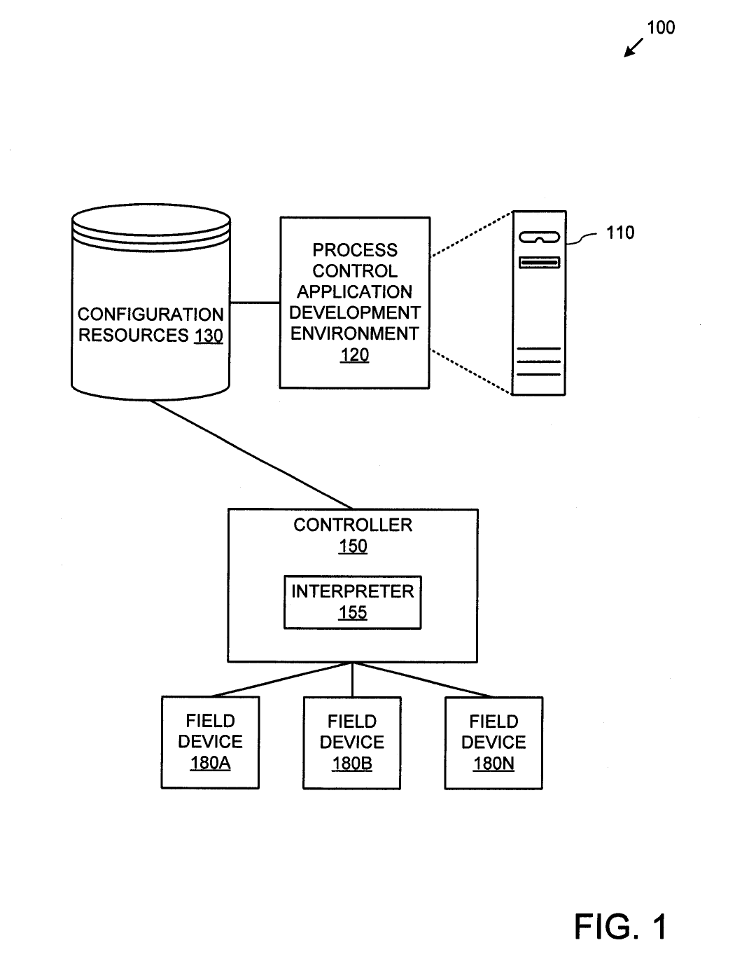

Due to the complexities involved with process control, various software tools can be used to help develop and manage the process control system. FIG. 1 is a block diagram of an exemplary process control system 100. A computer 110 executes a process control application development environment 120 which has access to various configuration resources 130, which can be implemented in a database server and include high-level representations of process control applications.

A process controller 150 is in communication with the database server implementing the configuration resources 130. The process controller 150 includes an interpreter 155 for executing the high-level representations and is in communication with the field devices 180A-N to execute the process control applications.

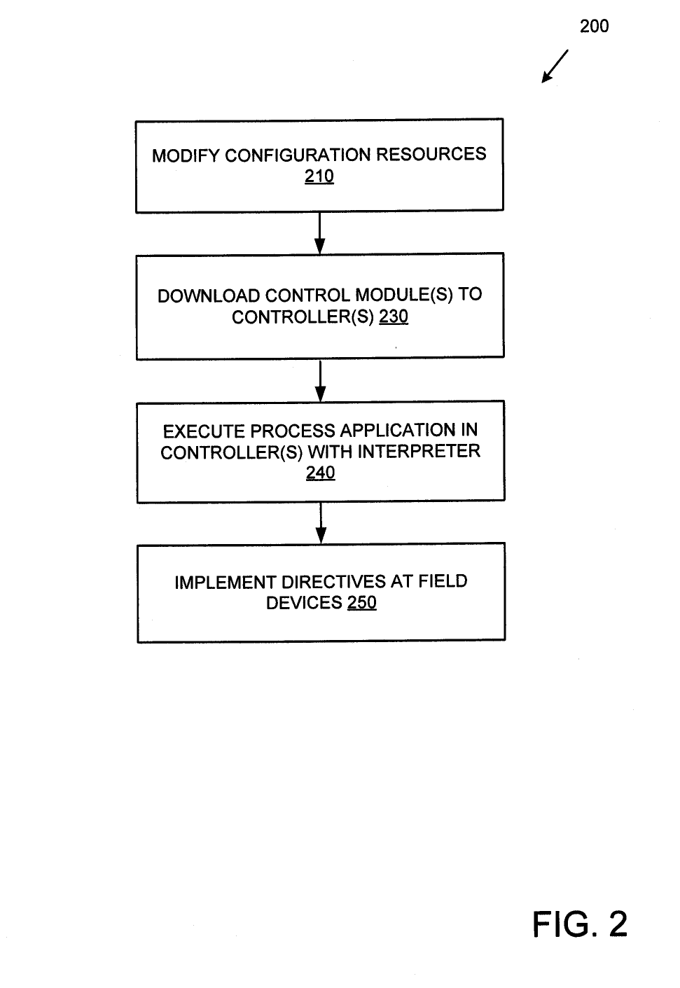

FIG. 2 is a block diagram of an exemplary method 200 of implementing process control. At 210, configuration resources are modified to achieve modification of the high-level representation of a process control application. When development reaches an appropriate stage, at 230, the represented process control application can be downloaded to the process controller 150, which executes the application at 240 via an interpreter. During execution, the controller 150 communicates with the field devices 180A-N to implement the process control process at 250. During execution of the process control application by the controller, information can continue to be exchanged with the computer 110 or another computer to monitor the process and allow operator input.

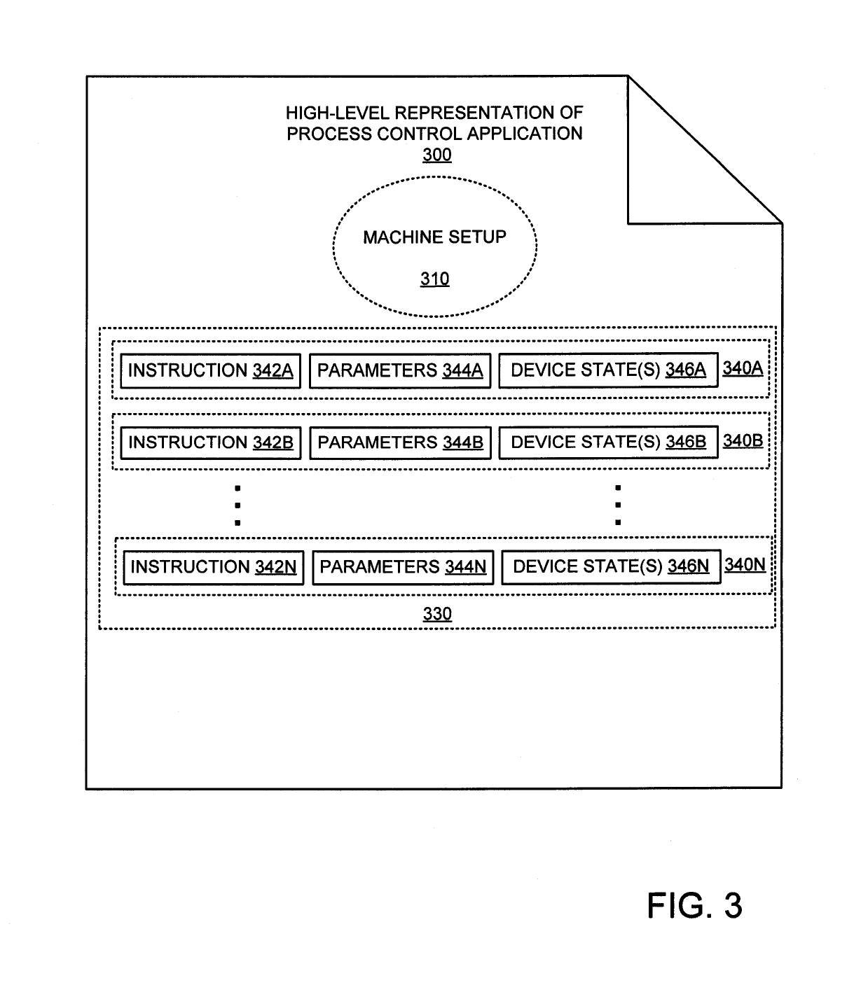

FIG. 3 shows that a process control application can be represented as an exemplary high-level representation 300 of the process control application. A machine setup 310 provides an arrangement of field devices, which can be displayed for the developer. A set 330 of high-level application directives can include individual directives 340A-N. A directive 340A can include a high-level instruction 342A, parameters 344A, and device states 346A.

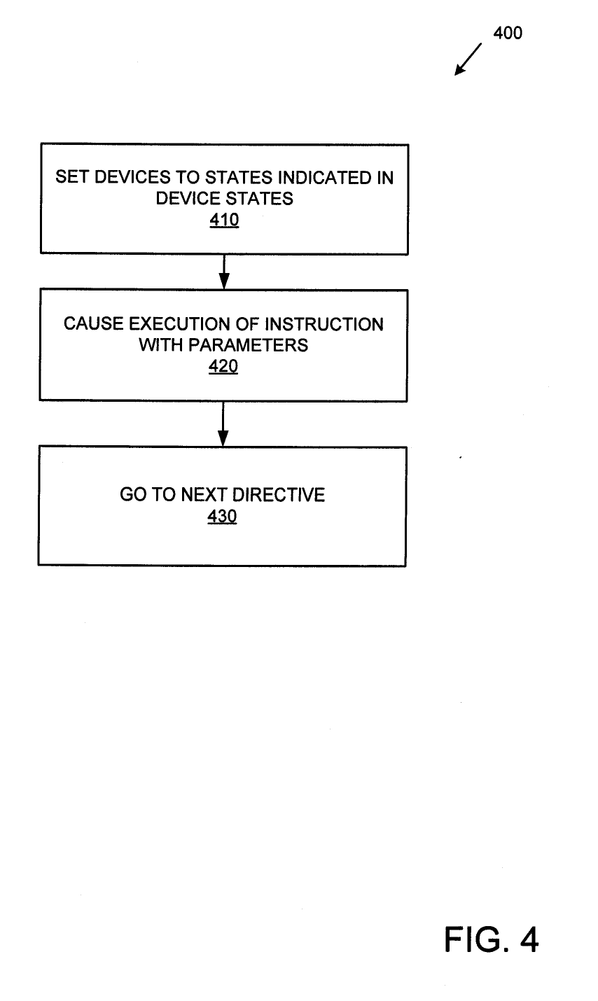

FIG. 4 is a block diagram of an exemplary method 400 of executing a high-level representation of a process control application. At 410, the field devices are set to the states indicated in the device states of a high-level directive. At 420, the execution of the high-level instruction is caused by the interpreter. Then, the next high-level directive is processed at 430.

### Example 2

### Exemplary High-level Representations of Process Control Applications

In any of the examples herein, a process control application for a process control process can be represented during development as a high-level representation of the process control application for the process control process. Discrete process control, batch process control, continuous process control, and the like can be implemented. Distributed Control System (DCS), Programmable Logic Controller (PLC), HMI, PC base control, and general logic solver operation can be supported.

For example, the process control application that is executed by the controller can involve low level (e.g., machine or assembly) instructions specific to the controller (e.g., specific to the vendor or proprietary system implemented by the vendor). The high-level representation of the application can serve as an abstraction layer above the low level instructions, thus representing the application in a vendor-independent language. An interpreter at the controller can execute the high-level representation and implement the appropriate low level instructions.

In this way, a wide variety of systems (e.g., the DeltaV digital process control system of Emerson Process Management, Allen-Bradley systems of Rockwell Automation, Modicon systems of Schneider Electric, WonderWare InTouch Systems, Intellution systems, etc.) can be supported with a single, uniform high-level representation. Thus, the high-level process control applications herein can be implemented as controller-type-independent representations.

When executed by the interpreter, the high-level process control application can function similarly to other process control applications, causing operations to be performed in a process plant (e.g., manufacturing, chemical, petroleum plant, or the like). For example, the techniques described herein can be used to write applications for manufacturing any of a variety of other materials, such as semiconductor, food, agriculture, pharmaceutical, industrial, consumer products, and the like.

Although shown in simple terms for the sake of illustration, in practice, the systems described herein can be more or less complicated, with additional functionality, more instructions, more field devices, more machines, and the like.

For the sake of convenience, a process control application for implementing a process control process is sometimes called a “process control application” or simply an “application” herein. Such an application can be executed by a controller as described herein.

### Example 3

### Exemplary Transformation

In practice during development, the high-level representation of the application can be stored in a form convenient for storage, edit, and manipulation (e.g., as database records or the like). If so, when the high-level representation is downloaded to the controller, it can be transformed into a format more suitable for the controller (e.g., flat file in block format). Or, the controller can interpret the same form stored during development.

### Example 4

### Exemplary High-level Directives

In any of the examples herein, a high-level representation of a process control process can comprise high-level directives, in an executable portion of the representation. As described herein, the high-level directives can include instructions with parameters. The directives are called “high-level” because they are ultimately reduced to lower-level (e.g., controller-level) instructions (e.g., by an interpreter at the controller) at runtime.

For the sake of convenience, a collection of high-level directives is sometimes referred to as a “script.” In such a case, a high-level directive can be referred to as a “script line.” However, the described high-level directives differ from other scripting languages in that they can be associated with device state patterns and implement other features as described herein.

### Example 5

### Exemplary Field Devices

In any of the examples herein, a field device can be a pump, valve, compressor, heater, vacuum system, refrigeration system, and the like. In practice, a field device can accept communications from and send communications to a controller. Many field devices can implement state (e.g., be turned on or off).

Any operations described herein as applied to field devices can also be defined to be applied to process devices. In addition to including field devices, process devices can include virtual devices, such as exception handling agents (e.g., to turn them on or off), and the like.

### Example 6

### Exemplary System Performing High-Level Representation Validation

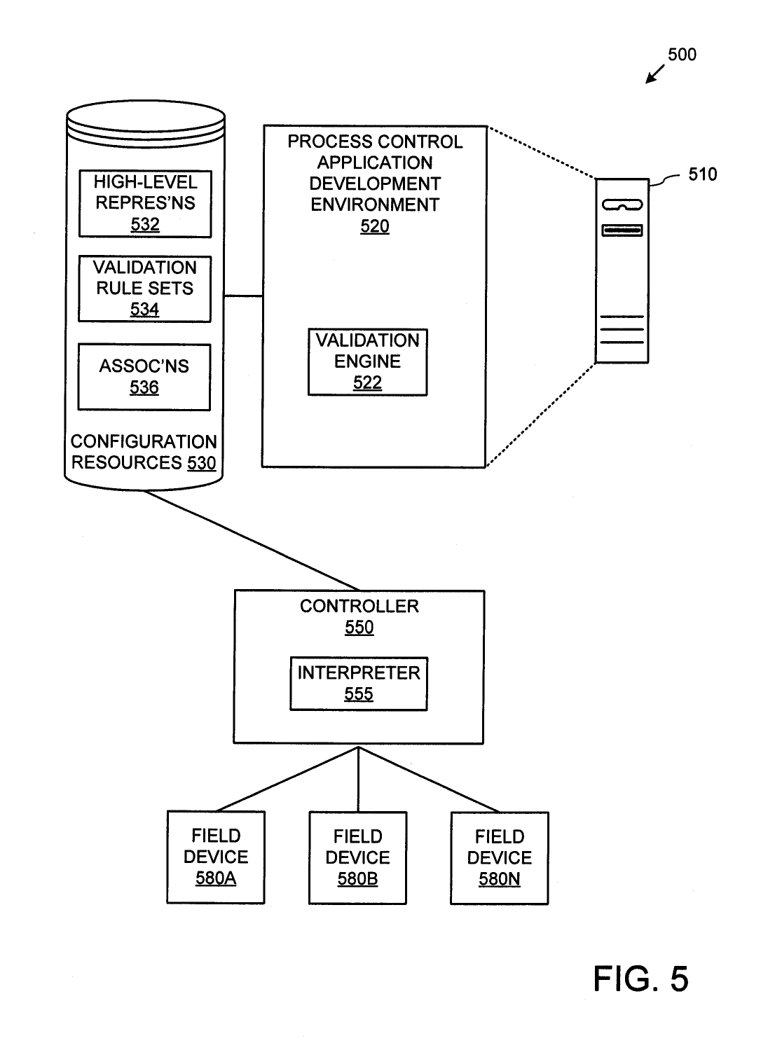

FIG. 5 is block diagram of an exemplary system 500 for performing validation of a high-level representation of a process control application.

In the example, a computer 510 executes a process control application development environment 520 that supports a validation engine 522. In practice, the validation engine 522 can be part of, partially contained in, or separate from the development environment 520.

The configuration resources 530 are accessible by the development environment 520 and can include a plurality of high-level representations 532 of process control applications associated with a plurality of validation rule sets 534 via a plurality of associations 536. For example, the associations 536 can associate the high-level representations 532 with respective validation rule sets 534. As described herein, the associations 536 can take the form of mappings, class membership, or other mechanisms.

Communication can also be implemented between the configuration resources 530 (e.g., a data base server) and one or more controllers 550, which can include an interpreter 555 for executing a high-level representation; the controllers 550 are in turn in communication with the field devices 580A-N.

Although not shown, it is also possible to have direct communication between other described items (e.g., between the computer 510 and the one or more controllers 550). In practice, additional computers can be used (e.g., one for development, one for operation, and the like).

### Example 7

### Exemplary Method of Performing Validation

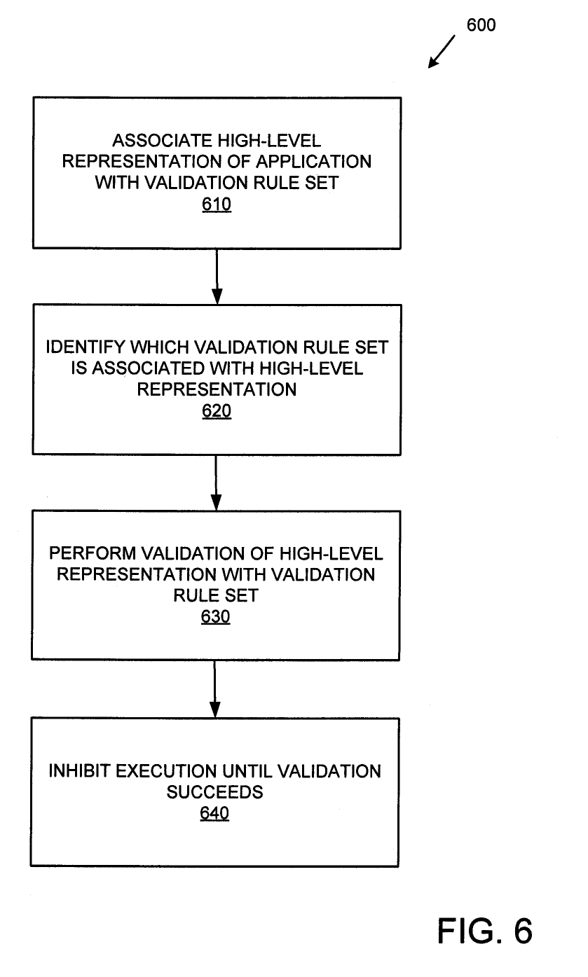

FIG. 6 is a flowchart of an exemplary method 600 of performing validation of a high-level representation of a process control application and can be used, for example, in the system 500 of FIG. 5.

In the example, at 610, the high-level representation of a process control application is associated with a validation rule set. In practice, association can be accomplished by storing a relationship between the high-level representation and the rule set.

At 620, the validation rule set associated with a high-level representation is identified. As described herein, different validation rules can be used for different high-level representations. For example, a per-high-level representation rule set association can be accomplished. The rule set designated for one high-level representation can be changed independently of the rule set designated for another high-level representation.

At 630, validation of the high-level representation with the identified validation rule set is performed. For example, validation can indicate success or failure.

At 640, execution of the process control application represented by the high-level representation is inhibited until validation succeeds. For example, the development environment can prevent download of the application to any controller until the validation succeeds. In another example, the validation process can be incorporated into the download process, wherein validation is automatically performed before download, and the process stops if validation fails. As described herein, validation can be incorporated into an approval process so that only an application that is successfully validated can be approved (e.g., for download).

The method 600 and any of the methods herein can be performed by computer-executable instructions stored in one or more computer-readable media (e.g., storage or other tangible media) or stored on a computer program product.

### Example 8

### Exemplary High-level Representation-Rule Set Associations

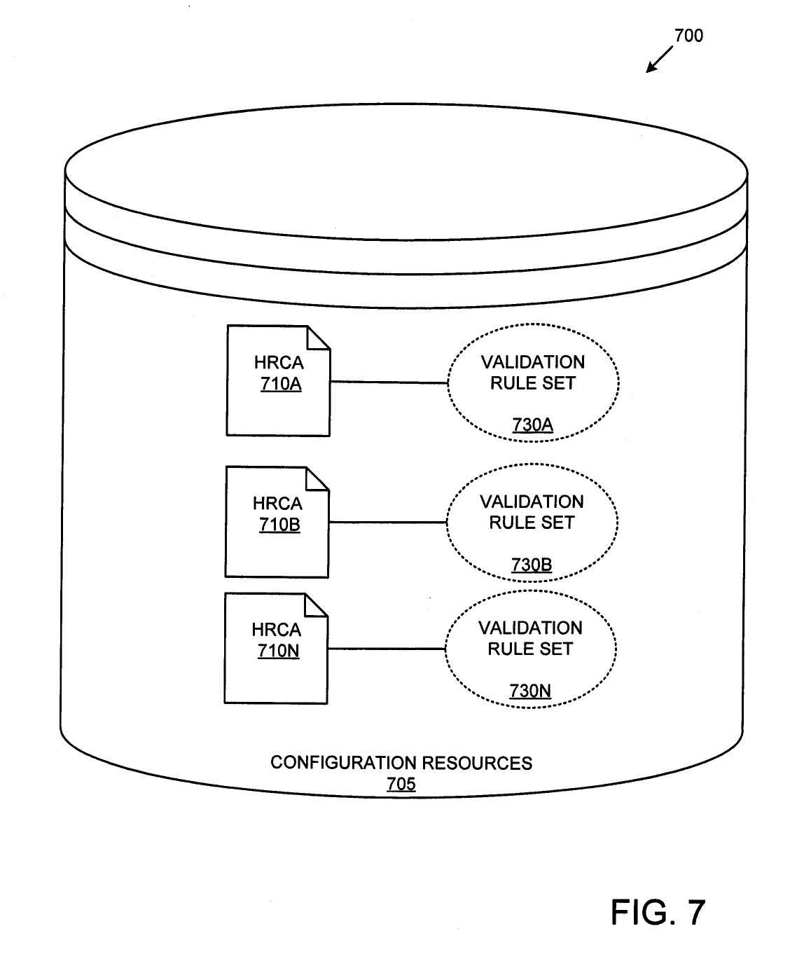

FIG. 7 is block diagram of an exemplary system 700 for associating high-level representations with validation rule sets, which, in the example, are stored as configuration resources 705.

In the example, a mapping is stored between high-level representations 710A-N and respective validation rule sets 730A-N. For example, a high-level representation 710A is associated with a validation rule set 730A via a mapping between the two. The validation rule set 730A is thus designated as the rule set to be used when performing validation of the high-level representation 710A.

Although a one-to-one mapping is shown, other arrangements (e.g., one-to-many, many-to-one, many-to-many) are possible. For example, more than one high-level representation can be mapped to a single rule set. In such a case, a change to the single rule set will affect validation of the high-level representations mapped thereto.

Associations can be accomplished in a variety of ways, such as storing a mapping from a high-level representation identifier to a validation rule set identifier in a database record. Levels of indirection (e.g., mapping to an intermediary entity, which then maps to a validation rule set) can be supported. Mapping can be reflexive.

### Example 9

### Exemplary Method of Associating and Identifying

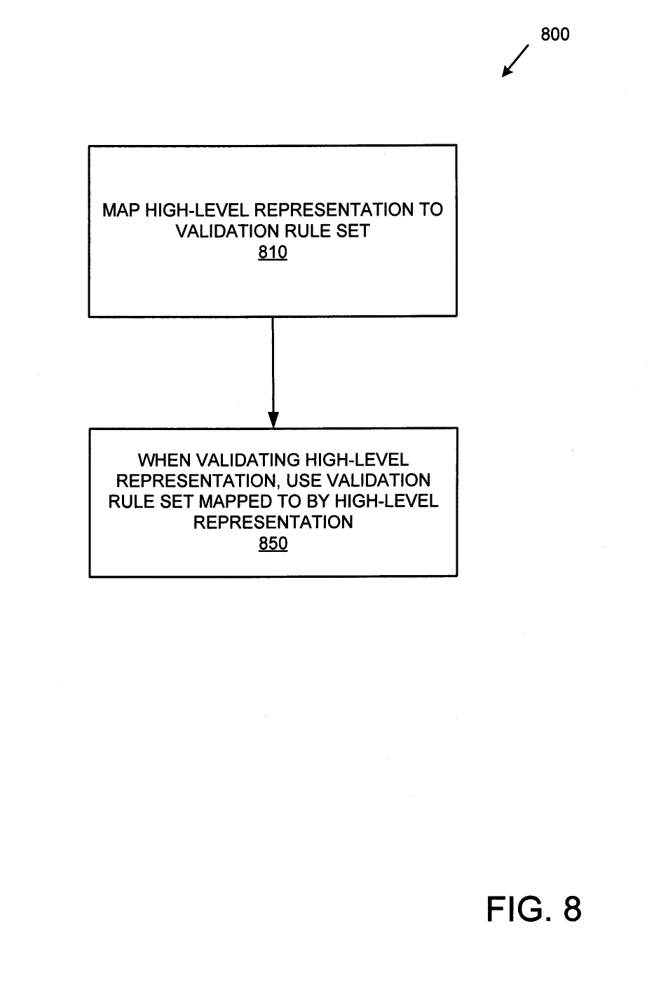

FIG. 8 is a flowchart of an exemplary method 800 of associating a high-level representation to a rule set and identifying which rule set is to be used when validating a high-level representation of a process control application.

At 810, a high-level representation of a process control application is mapped to a validation rule set. For example, an association between the two can be stored in configuration resources.

At 820, when validating the high-level representation, the validation rule set mapped to by the high-level representation is identified as the one to be used.

### Example 10

### Exemplary Approval

In any of the examples herein, in addition to successful validation, execution (e.g., via download) of a process control application can be inhibited until the high-level representation is approved by a user, such as an administrator or supervising user. The approving user can be required to be someone other than the person requesting approval or someone other than the user who last changed the high-level representation.

In such an arrangement, the status of approval can be stored in addition to or in combination with the status of validation.

Such an arrangement can be beneficial in that the high-level representation is presented to a second pair of eyes before the process control application can be executed.

### Example 11

### Exemplary Validation Rule Sets

In any of the examples herein, a validation rule set can be a set of one or more rules that are used to validate a high-level representation of a process control application. In practice, such a rule set is typically identified by a rule set identifier (e.g., a number, identifier, filename, or the like).

### Example 12

### Exemplary Validation Rules

In any of the examples herein, a validation rule can include application-specific or machine-specific rules. So, for example, if a particular situation is known to arise in an application or machine, the rules can be tailored to address the situation.

For example, a rule can specify that certain field device state patterns (e.g., valve patterns), machine states, directive sequences, directive patterns, analog limits (e.g., pressure, temperature, flow, level, and the like), and the like are disallowed because they would result in a quality, safety, or operational problem for the application or machine, which may be related to generating a particular product in a process (e.g., manufacturing process, chemical process, or petroleum process).

Thus, rules can go beyond checking syntax and can detect issues in syntactically correct high-level representations.

The rules can implement proprietary operating methods and rules of practice that are typically maintained in the heads of process experts. By embodying such expertise in rules, the validation can prevent costly quality, safety, or operational errors.

### Example 13

### Exemplary Method of Validating

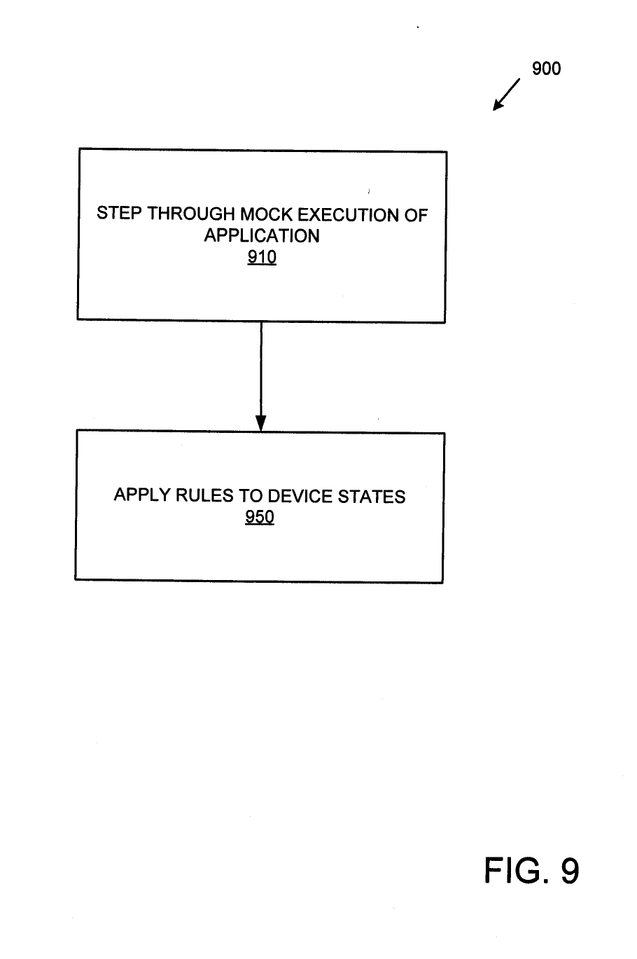

FIG. 9 is a flowchart of an exemplary method 900 of validating a high-level representation of a process control application. In the example, the process control application represented by the high-level representation is stepped through during a mock execution at 910. As described herein, actual execution is inhibited until validation is successful.

At 950, validation rules from the validation rule set are applied to field device states. For example, if there are n rules, validation can proceed by applying rules 1-n against the field device states to see if there are any device state patterns identified as impermissible or disallowed (e.g., four valves being open at the same time, two pumps pumping at the same time, pump x pumping when valve y is closed, or the like). Thus, the expected state of a field device during execution of the represented process control application can be checked.

### Example 14

### Exemplary Method of Validating

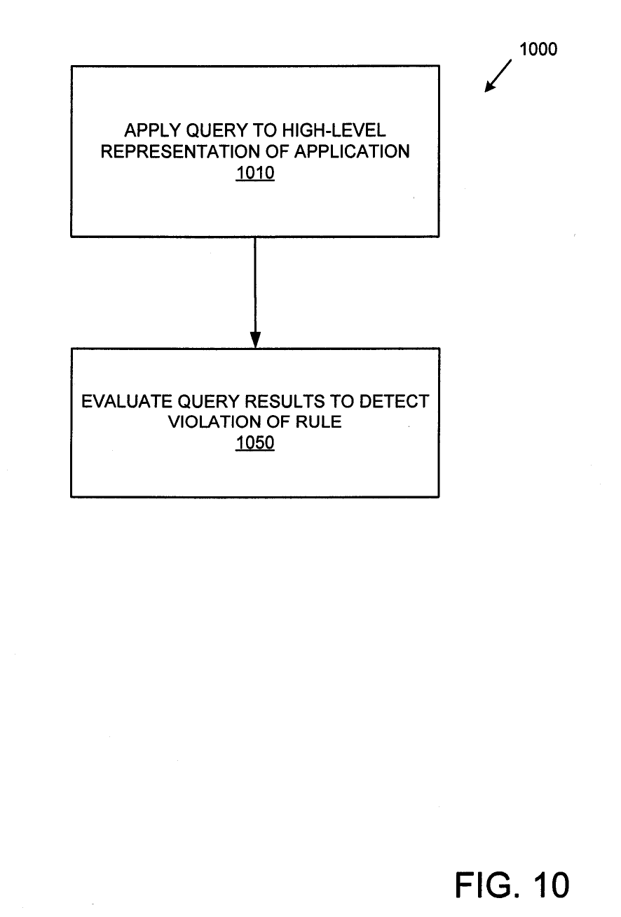

FIG. 10 is a flowchart of another exemplary method 1000 of validating a high-level representation of a process control application.

At 1010, a query is applied to the high-level representation of the application.

At 1050, the query results can then be evaluated to detect violation of a rule (e.g., any of the rules in the validation rule set). Thus a validation rule set can take the form of a set of queries.

For example, the query can check field device states to see if any prohibited combinations are present in the field device states. Responsive to determining that there are no prohibited combinations, the validation outcome can be designated as successful.

If the field device states are stored as configuration resources, queries against the configuration resources can detect the expected state of a field device during execution of the represented process control application.

### Example 15

### Exemplary Data Structure for Indicating Validation Status

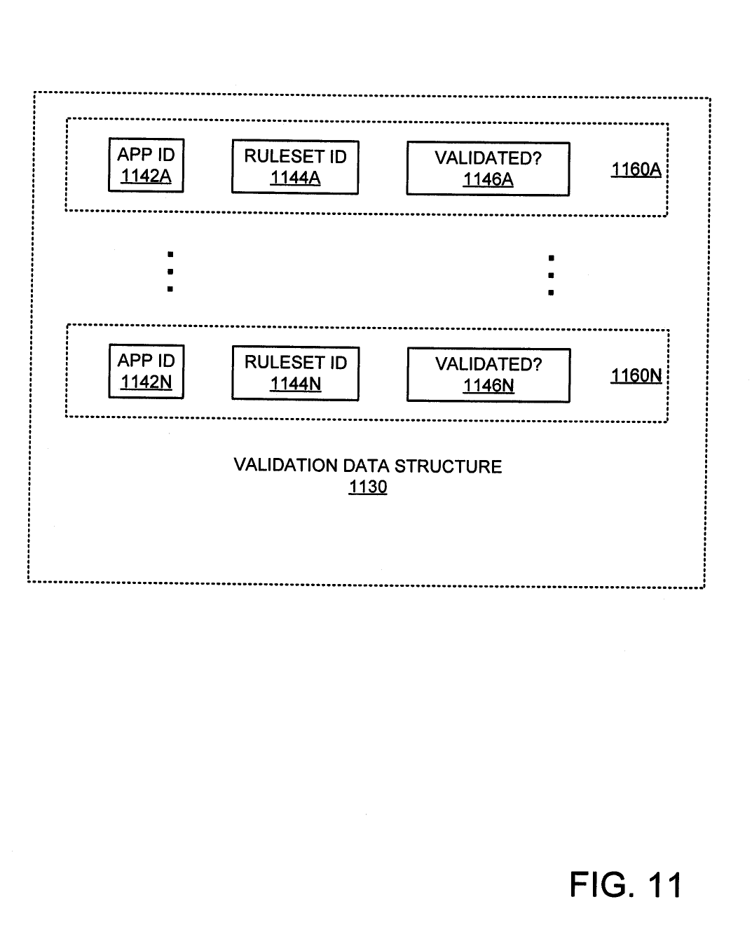

FIG. 11 is a block diagram of an exemplary data structure 1130 for indicating validation status of a high-level representation of a process control application. In practice, any number of other arrangements is possible.

In the example, a data structure 1130 contains records 1160A-N for various high-level representations of applications. The records 1160A-N contain fields that indicate an application identifier 1142A and a respective rule set identifier 1144A that identifies the rule set to be used when validating the high-level application identified by the identifier 1142A. Another field 1146A indicates whether the application has been validated. For example, whenever the high-level application is modified via editing, the validated field 1146A can be set to false. Before any validation is performed, the field can be set to false, unvalidated, or the like. Upon successful validation, the validated field 1146A can be set to true. Another record 1160N contains similar fields 1142N, 1144N, and 1146N.

### Example 16

### Exemplary Method for Enforcing Validation via Data Structure

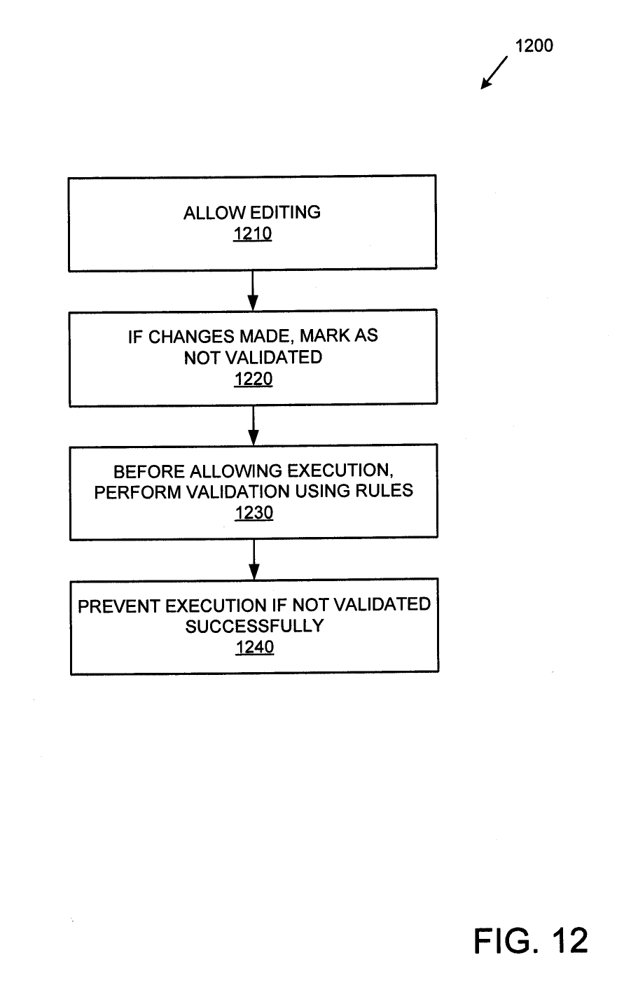

FIG. 12 is a flowchart of an exemplary method 1200 of enforcing validation during development of a high-level representation of a process control application.

At 1210, editing of a high-level representation of a process control application is permitted. For example, a user can use a user interface to make various changes to the high-level representation. Responsive to detecting that any changes have been made, the high-level representation is marked as not validated (e.g., false) at 1220. Other mechanisms can be used. For example, a time stamp of the most recent validation and a time stamp of the most recent change can be stored.

At 1230, before execution of the represented application is allowed, validation is performed using the rule set associated with the high-level representation as described herein.

At 1240, execution is prevented if validation is not successful. For example, download of the application to the controller can be inhibited.

### Example 17

### Exemplary Method of Downloading Application to Controller

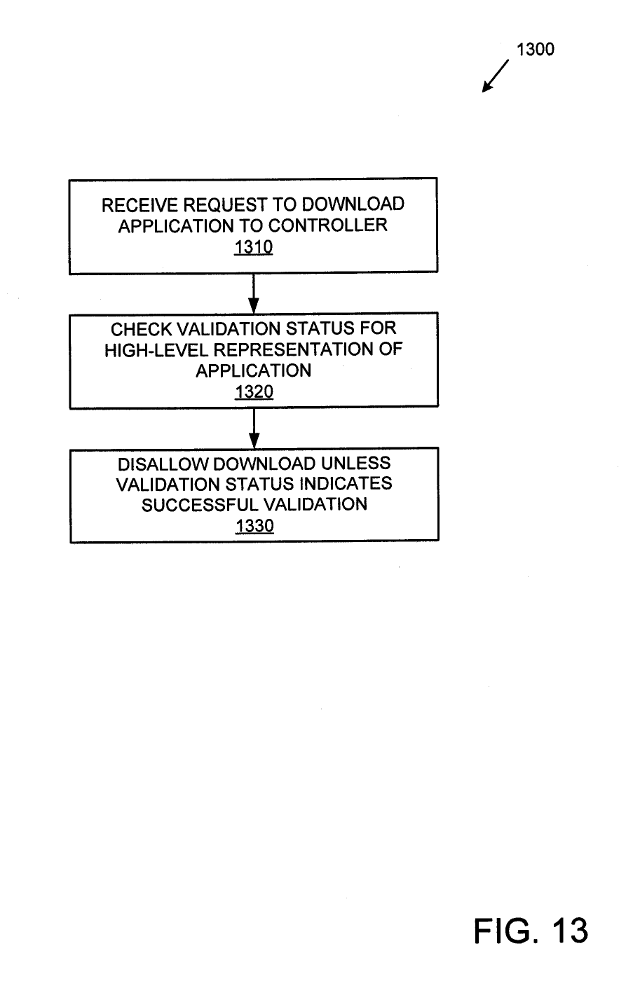

FIG. 13 is a flowchart of an exemplary method of downloading an application to a controller while enforcing validation of a high-level representation of a process control application. The validation process can be incorporated into a downloading process.

At 1310, a request is received to download a represented application to a controller. For example, a user can request, via a user interface, that the application be downloaded to a controller.

At 1320, responsive to receiving the request to download, validation status of the high-level representation can be checked. For example, a field can be checked to see if validation is successful. Or, validation of the high-level representation can be performed using an associated rule set, returning validation success or failure.

At 1330, download is disallowed (e.g., the process stops, an error message is displayed, or the like) unless the validation status indicates successful validation.

### Example 18

### Exemplary Manual Validation

In any of the examples herein, validation can be performed responsive to a manual request (e.g., without the download request 1310). For example, an activatable “validate” user interface element (e.g., button) can be provided for the high-level representation. As described herein, execution of the application (e.g., by preventing download) is inhibited responsive to determining that validation fails for the high-level representation.

### Example 19

### Exemplary Machine Setup

A high-level representation of a process control application for a process control process typically includes a machine setup. The machine setup can include an arrangement of field devices and connections between the field devices. High-level directives of the high-level representation are typically associated with respective state patterns of the field devices. As execution steps through the directives, the states of the field devices in the machine setup are set to those states associated with the high-level directives. In practice, the machine setup can be shown in a user interface during development of the application. When a particular directive is selected, the user interface can depict the field devices in the machine setup as having the associated states. For example, an open valve can be shown in a particular color (e.g., green), but if the valve is open, it can be shown in a different color (e.g., red).

For purposes of convenience, a machine setup is sometimes called a “machine.” In any of the examples herein, a machine setup can be identified as being of a machine class. A high-level representation of a process control application can be associated with a particular machine class. In this way, separate copies of the same machine need not be saved for different high-level representations.

In practice, a machine can be first implemented as a machine class. Machines are members (e.g., instances) of the machine class and inherit machine class definitions. An instance of a machine class implements specific location and mappings to an appropriate controller.

### Example 20

### Exemplary System Using Class Membership to Implement Association

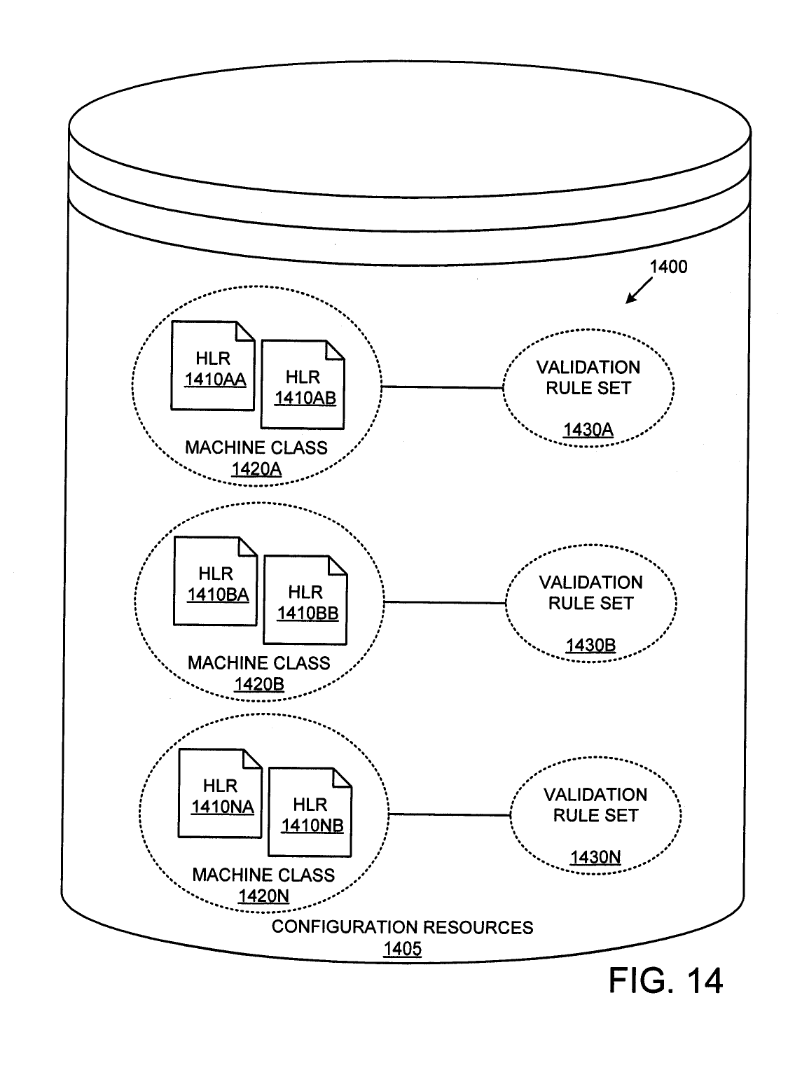

FIG. 14 is a block diagram of an exemplary system 1400 for associating high-level representations of process control applications with validation rule sets using a class mechanism. In the example, the associations are accomplished via configuration resources 1405.

In the example, high-level representations 1410 of process control applications include machine setups having machine classes 1420. The machine classes are then associated with validation rule sets 1430. So, for example, the high-level representation 1410AA includes a machine setup of class 1420A, which is associated with the validation rule set 1430A. Thus, the high-level representation 1410AA is associated with the validation rule set 1430A via class membership of its machine in class 1420A, and the validation rule set 1430A will be identified as the rule set to be used to validate the high-level representation 1410AA.

Changes to the validation rule set 1430A will be propagated to those representations using a machine of class 1420. In this way, a change to a single rule set 1430A can result in application of the change to a plurality of high-level representations 1410AA, 1410AB. Such an arrangement has advantages in that it requires storage of fewer rule sets 1430. There are also typically fewer errors because the administrator does not need to propagate changes to plural rule sets when making changes for a group of high-level representations.

### Example 21

### Exemplary Data Structure for Accomplishing Class Membership

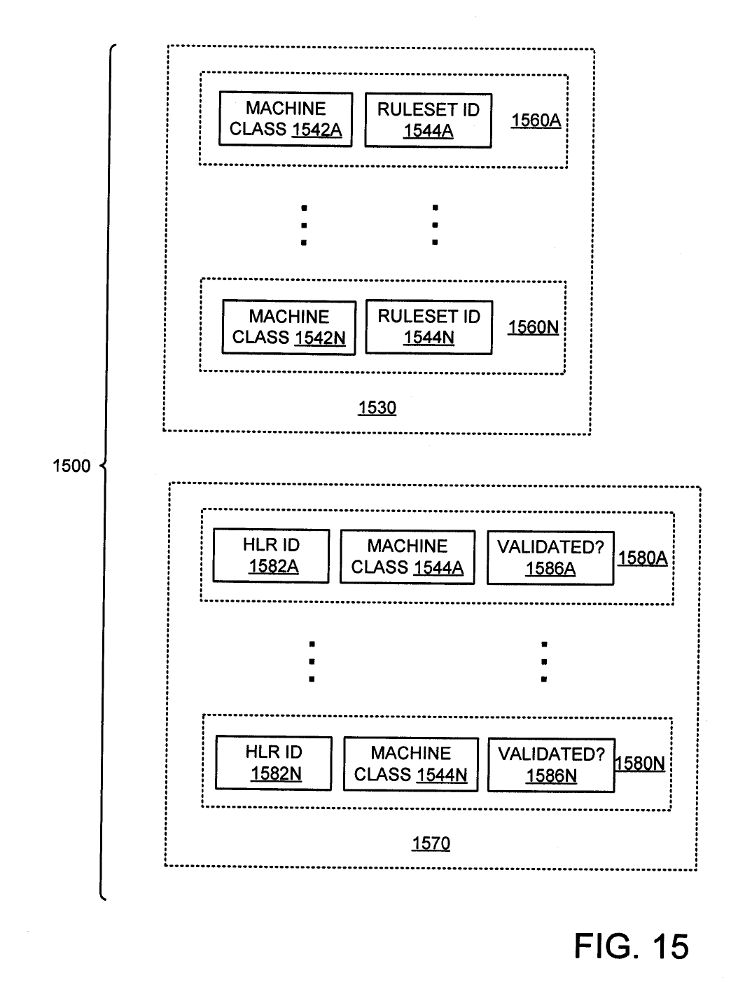

FIG. 15 is a block diagram of an exemplary data structure 1500 for associating high-level representations of process control applications with validation rule sets using a class mechanism. In practice, other arrangements can be used, such as linked lists, arrays, or the like.

In the example, there are two sets of records 1530 and 1570. The first set 1530 contains records 1560 that associate a machine class identified by a identifier 1542 with a respective rule set identified by an identifier 1544. So, in the example, the class identified by the identifier 1542A is associated with the rule set identified by the identifier 1544A.

The second set 1570 contains records 1580 that associate a high-level representation identified with an identifier 1582 with a machine class identifier 1544A. Another field 1586 can be included to indicate whether the high-level representation identified by the identifier 1582A has been validated.

### Example 22

### Exemplary Method of Associating Rule Set with Newly-created Representation

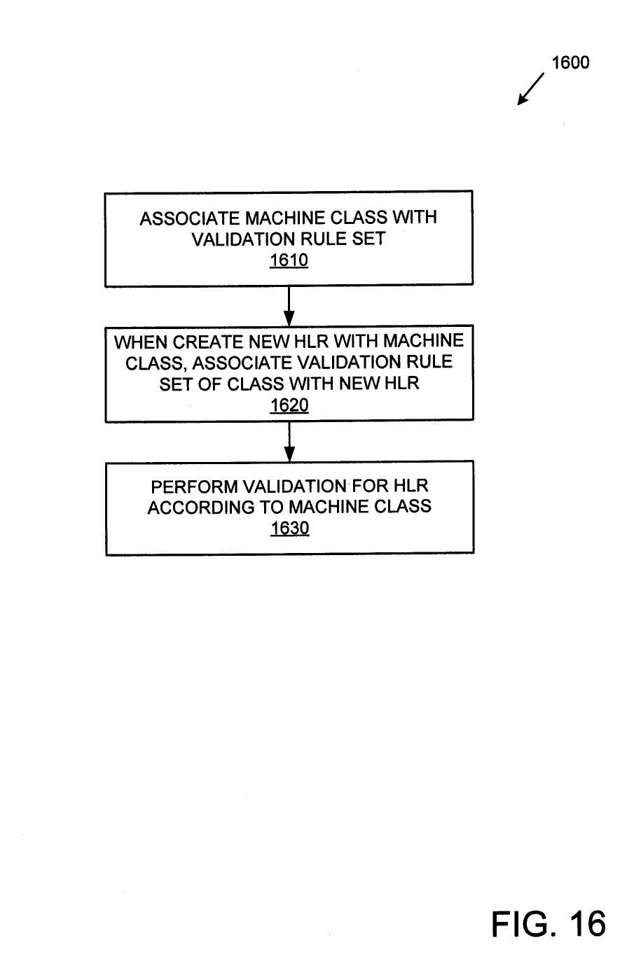

FIG. 16 is a flowchart of an exemplary method 1600 of performing validation for a high-level representation of a process control application according to the machine class.

In the example, at 1610, a machine class is associated with a validation rule set. As described herein, such an association can be accomplished by storing a relationship between identifiers.

At 1620, when a new high-level representation is created, it can be designated as being of a particular machine class. When a new high-level representation of a class is created, the validation rule set associated with the class is in turn associated with the new high-level representation. Such association can be indicated by virtue of the fact that the representation uses the machine class for the representation's machine setup.

At 1630, validation for the high-level representation is performed according to the machine class. So, the validation rule set associated with the machine class is used to validate the high-level representation of the process control application.

Although not shown in FIG. 16, using a class mechanism can have benefits beyond when creating a new high-level representation. For example, when changes to a single rule set associated with a machine class associated with multiple high-level representations are received, the changes are propagated to validations performed for the multiple high-level representations. However, the changes need not actually be copied to different rule sets to achieve propagation.

### Example 23

### Exemplary Implementation of Validation

Although any number of possible arrangements is possible, one implementation of validation can use a MICROSOFT SQL SERVER system. Validation rules can be free-form Transact-SQL statements.

### Example 24

### Exemplary Advantages of Validation Rule Sets

Using the validation techniques described herein can result in certain advantages. For example, validation in and of itself can reduce errors. Because the validations described herein can check field device states, certain quality, operational, and safety problems can be avoided. Because a validation can be designated for a particular high-level representation, peculiar issues for the high-level representation (e.g., a particular manufacturing process) can be addressed by the validation rules.

In a machine class scenario, modifications to a single rule set modifies the rule set used for machines of the class, reducing time needed to make modifications and reducing the amount of storage (e.g., memory or hard disk space) needed to store the rule sets when high-level representations share a machine class.

### Example 25

### Exemplary Configuration Resources

In any of the examples herein, configuration resources can be stored in a configuration store. The configuration store can take the form of a database, a collection of XML documents, or the like.

In the case of a database, configuration resources can be stored as records. Individual items can thus be configured by changing the records or fields thereof in the database. User interfaces can be provided to give a developer a structured way of achieving configuration (e.g., via pick lists, drop down menus, and the like).

### Example 26

### Exemplary Exception Handler Agents

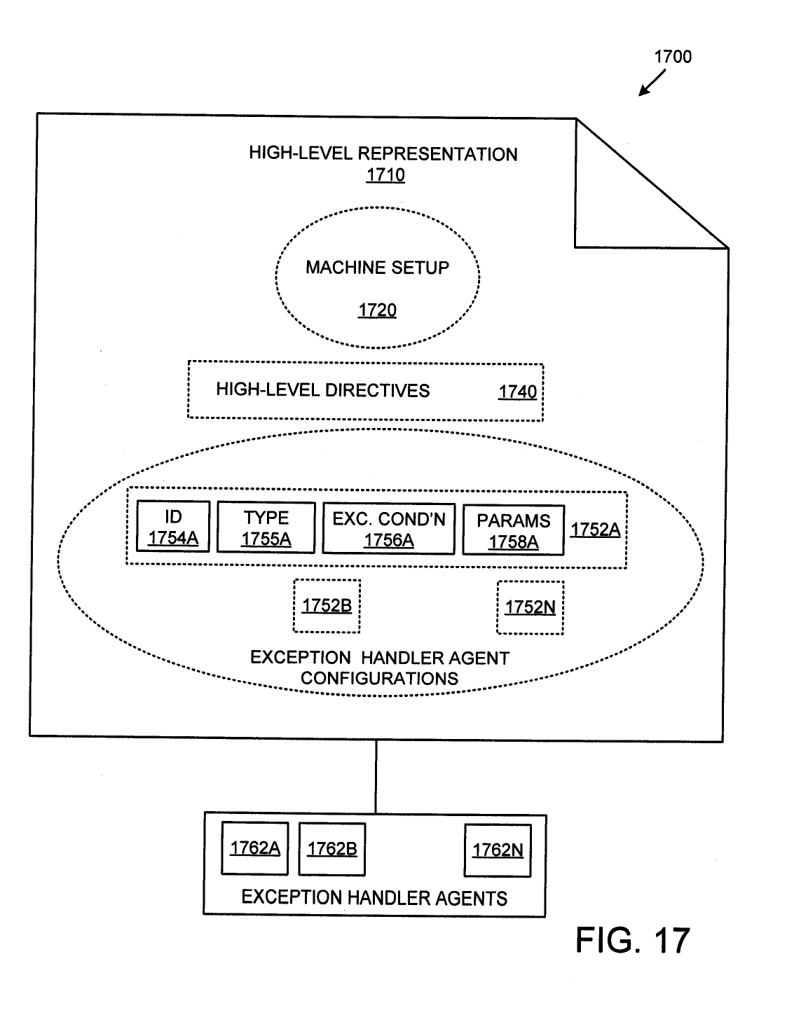

In any of the examples herein, exception handler agents can be invoked by a high-level representation of a process control application during execution. As described herein, configuration can also be achieved by the high-level representation during execution. FIG. 17 is a block diagram of an exemplary system 1700 for invoking exception handler agents 1762A-N in a high-level representation of a process control application 1710 for a process control process.

In the example, a high-level representation 1710 comprises a machine set up 1720, high-level directives 1740, and exception handler agent configurations 1752A-N. The shown items can be stored as configuration resources as described herein in a process control development environment (e.g., as shown in FIG. 1) or stored within a controller for execution via interpretation.

The exception handler agents 1762A-N can be invoked by the high-level representation 1710 and can be implemented as part of an interpreter that processes the high-level directives 1740 (e.g., in a controller). For example, the interpreter can process the configurations 1752A-N to implement the agents 1762A-N. In practice, the configurations 1752A-N can be implemented as special high-level directives 1740 (e.g., via an exception handler agent configuration instruction specifying the configuration as parameters).

As shown, the exception hander agent configurations 1752A-N can include respective identifiers 1754A, types 1755A, exception conditions 1756A, and additional parameters 1758A. In some cases, a parameter (e.g., a resume line, not shown) may not be necessary due to the nature of the agent.

### Example 27

### Exemplary Exception Handler Agent Types

In any of the examples herein, exception handler agents can be of different types. Three possible types are hold, permissive, and alarm. So, such an agent is sometimes called an “HPA agent.”

A hold exception handler is characterized by interrupting execution (e.g., diverting execution to another line) of the process control application upon detection of a condition and requiring some sort of operator intervention before execution is allowed to resume. For example, a message can be displayed on an operator console, and execution of the application can halt until the operator acknowledges receipt of the message. Typically, the message will instruct the operator to resolve the detected condition.

A permissive exception handler is characterized by interrupting ordinary program flow (e.g., diverting execution to another line) of the process control application upon detection of a condition, but attempting to resolve the condition with program logic (e.g., exception handler logic). Program execution is typically diverted to exception handling logic within the process control application, and ordinary execution continues after the condition is resolved. For example, if a value exceeds a limit, instructions can take steps to reduce the value and then resume where interruption took place. When the condition is resolved, execution can resume at a location specified by the interrupted instruction. Or, a custom permissive exception handler can override the resume location specified by the interrupted instruction. Execution need not return (e.g., directly) to where the interruption took place. Instead, execution can resume at a specified location within the directives (e.g., a line number).

An alarm exception handler is characterized by simply sending a notification to an operator. Although a brief interruption can take place, execution of the high-level directives is not diverted. For example, a message can be displayed on an operator console, or an email can be sent to the operator. Execution of the application need not be further affected or interrupted.

As described herein, an exception handler agent can be configured to be any of the described exception handler agent types. In some cases, surplus parameters need not be used. For example, a resume line for an alarm is not needed because execution is not diverted from the ordinary path.

### Example 28

### Exemplary Exception Handler Agent Identifiers

In any of the examples herein, the exception handler agents can be identified by respective identifiers. For example, integer numbers, names, and the like can be used. In practice, exception handler agent configurations can specify the agent being configured. In this way, as described below, the same agent can be configured more than once (e.g., agents can be re-used). In one implementation, 128 agents are identified by numbers 1-128. But, in another implementation, there is no particular limit to the number of possible agents. In practice, more than one agent can be configured and active at a time.

For usability, a descriptive name can be included in agent configuration information. The descriptive name can then be associated with the agent.

### Example 29

### Exemplary Exception Conditions

In any of the examples herein, an exception condition can be any of a variety of conditions detectable by the process control system. For example, a pressure reading, temperature reading, and the like can be checked. Comparison operators (e.g., greater than, less than, equal to, and the like) can be included. If desired, a threshold number of seconds can be specified (e.g., to avoid annoyance conditions).

In practice, such a condition is sometimes called a “process upset.”

To aid in configuration, conditions can be constructed via pick lists (e.g., a pick list of tags identifying various field devices; a pick list of comparison operators, and the like) presented to a user. The exception condition can be stored as associated with a particular exception handler agent (e.g., in an exception handler agent configuration instruction that configures the agent upon execution).

### Example 30

### Exemplary Exception Handler Agent Method

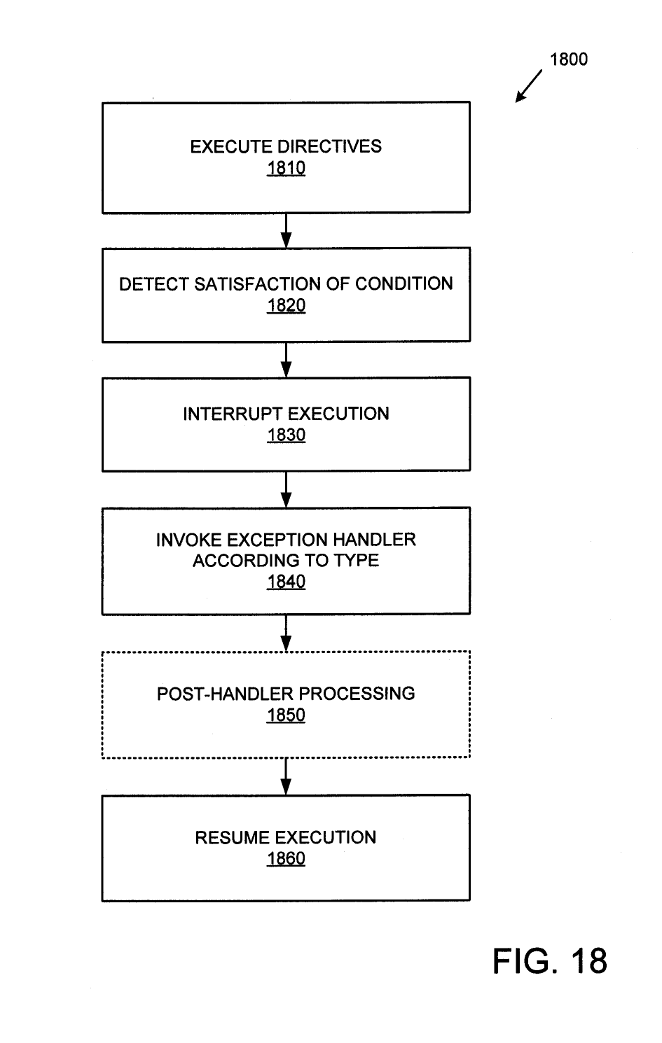

FIG. 18 is a flowchart of an exemplary method 1800 of implementing exception handler agents in a process control application, and can be implemented in a controller. A high-level representation of a process control application can include configuration information for exception handler agents. During development, a user can set up and change such configuration information. After the high-level representation is downloaded to a controller, the exemplary method 1800 can be performed in the controller to implement the exception handler agent configuration information in the high-level representation as executing agents at runtime.

In the example, at 1810, the controller executes directives of the high-level representation. Such execution can be accomplished via interpretation of the high-level representation by an interpreter at the controller. Configuration of the agents can be accomplished separately or by such directives.

At 1820, satisfaction of an exception condition associated with an exception handler agent is detected. For example, the controller can periodically scan for satisfaction of conditions every n milliseconds.

At 1830, responsive to determining that an exception condition associated with the agent has been satisfied, execution (e.g., of the high-level representation) is interrupted according to the configuration information for the agent (e.g., the agent type). In the case of an alarm, execution need not be diverted. Execution is interrupted only to the extent needed to process the alarm or direct another component of the system to process the alarm.

At 1840, the exception handler agent is invoked according to its type. For example, an exception handler agent of type “hold” can stop execution of the application and await user intervention. An exception handler agent of type “permissive” can divert execution to other high-level directives within the application. An exception handler agent of type “alarm” can provide an alarm to an operator.

In some cases, at 1850, post-handler processing can be performed. So, for example, execution can be set up to resume at a resume line, deadband processing can be performed to prevent premature resumption, and the like.

At 1860, execution of the high-level representation resumes.

### Example 31

### Exemplary Custom Permissive

In any of the examples herein, a high-level directive can include a parameter indicating a location (e.g., line number) with the high-level directive indicating where execution is to resume after a permissive exception is processed.

However, a special kind of permissive exception handler agent can be designated as a “custom permissive.” In such a case, the resume line specified by the high-level directive is overridden by the location specified by the permissive exception handler agent.

So, it is possible to have an exception handler agent designated as a custom permissive. If so, during post-handler processing (e.g., 1850), responsive to determining that the exception handler agent is designated as a custom permissive, execution is set up to resume at the location specified by the exception handler agent, rather than that specified in the high-level directive.

In the case of a hold, execution can resume at a hold resume location that is defined in the high-level directive that was interrupted when the hold was invoked.

### Example 32

### Exemplary Exception Handler Agent Logic

In any of the examples herein, an exception handler agent can be associated with logic. Particularly in the case of an exception of type “permissive,” logic can be designated as to be executed when the exception condition is detected. In such a case, invoking the exception handler agent (e.g., 1840 of FIG. 18) can include diverting execution (e.g., in the controller) to another section of the high-level representation that addresses the detected condition.

At the end of the logic, an instruction can be specified (e.g., “PermHoldStop”) that indicates that the condition is considered to be resolved by the exception handler agent logic. A deadband parameter can also be specified with the exception condition to disallow resumption of execution until the exception condition is resolved (e.g., by a certain amount or percentage).

It is possible for an exception condition associated with a second agent to be satisfied while still performing processing for a first agent. In the case of an exception handler agent of type “hold,” the hold takes precedence over the agent of type “permissive.” In such a case, the permissive is interrupted. After the hold is resolved, execution of the permissive can resume. So, a stack mechanism indicating where execution was interrupted can be used to track where execution resumes after the hold is resolved.

If two exception conditions are somehow satisfied simultaneously (e.g., in a same scan by the controller), exception handler agents can resolve a conflict via priority (e.g., a lower-numbered exception handler agent takes priority).

### Example 33

### Exemplary Exception Handler Agent Active Status Information

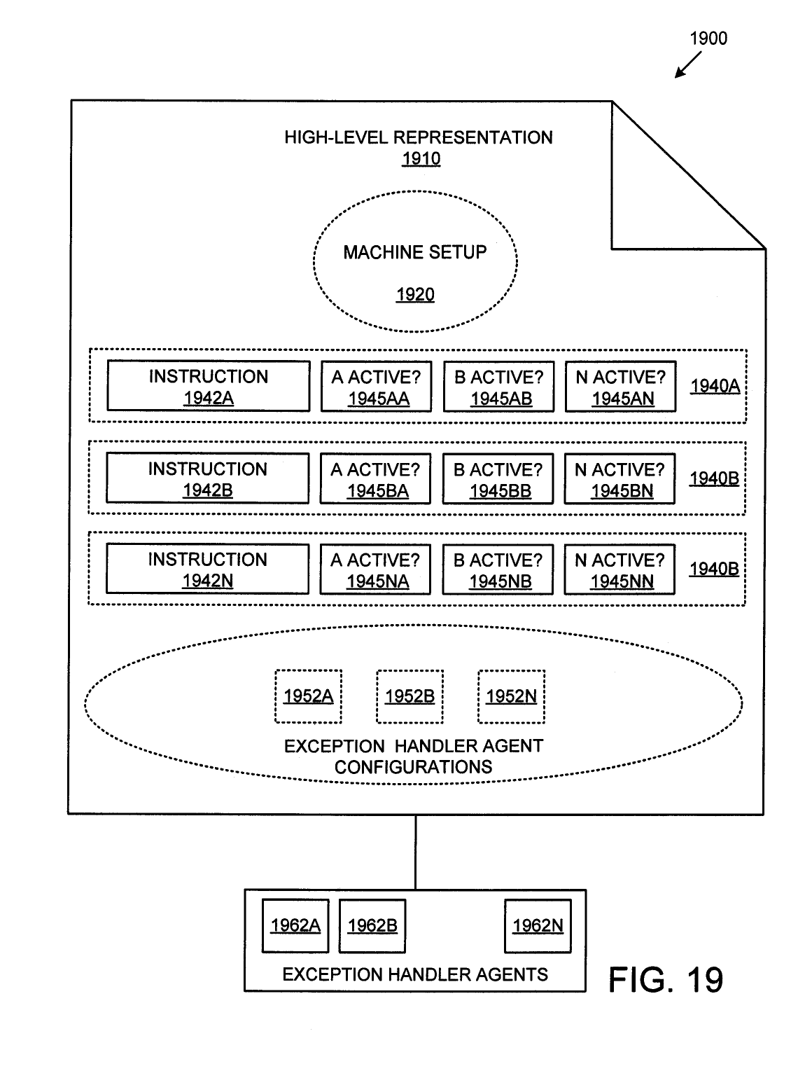

FIG. 19 is a block diagram of an exemplary system 1900 for implementing activating exception handler agents 1962A-N in a high-level representation 1910 of a process control application.

In the example, the high-level representation 1910 comprises a machine setup 1920, high-level directives 1940A-N with respective instructions 1942A-N and active information 1945. Configuration information for exception handler agents 1952A-N is also stored. The exception handler agents 1962A-N can be implemented as described in FIG. 17.

The representation 1910 contains indications 1945 indicative of whether an exception handler agent is active for a particular instruction. In any of the examples herein, an exception handler agent can be configured to be active or inactive per high-level directive. So, for example, as the high-level representation is executing, the agent can be active for a first directive and then be inactive when the second directive is being executed.

The indications of whether an exception handler agent can be stored in the same way field device state patterns are stored. So, for example, the exception handler agent can be considered a virtual field device or process device. State information can indicate whether the exception handler agent is on (activated) or off (inactivated). As with field device state information, such information can differ for different high-level directives. Thus, the exception handler agent active status can be stored as part of the field device state pattern for the directive.

### Example 34

### Exemplary Exception Handler Agent Configuration Method

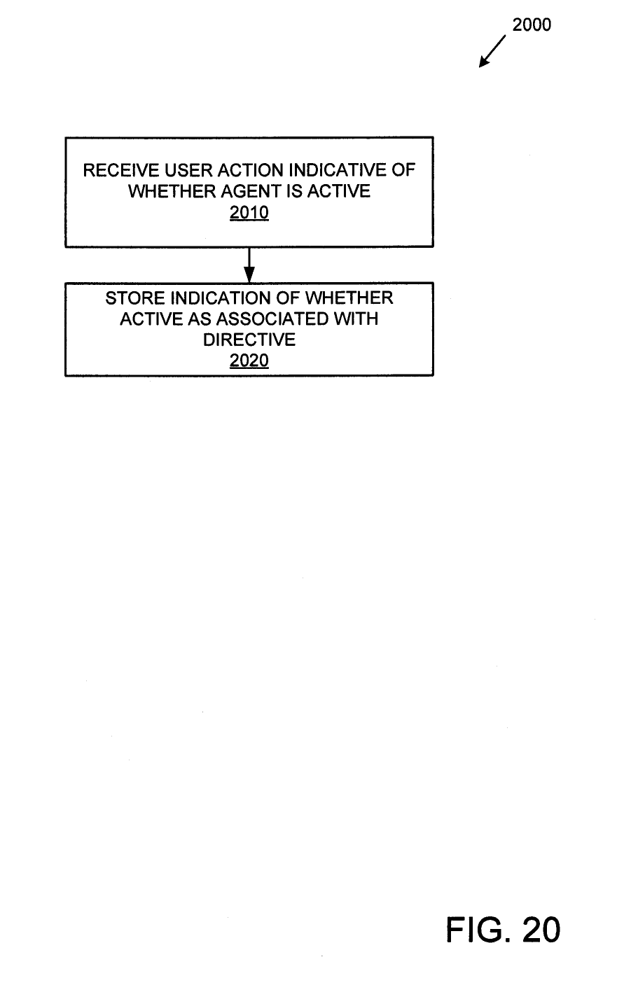

FIG. 20 is a flowchart of an exemplary method 2000 of configuring whether an exception handler agent is active. The method 2000 can be implemented in a process control application development environment.

At 2010, a user action indicative of whether an agent is active is received. For example, in the development environment, a user can click on a user interface element to indicate that the agent is active (e.g., for a particular high-level directive).

At 2020, responsive to the user action, an indication of whether the agent is active is stored (e.g., as associated with the particular high-level directive).

Although the example shows a single agent, it is possible to implement the method for multiple agents.

### Example 35

### Exemplary Exception Handler Agent Activation

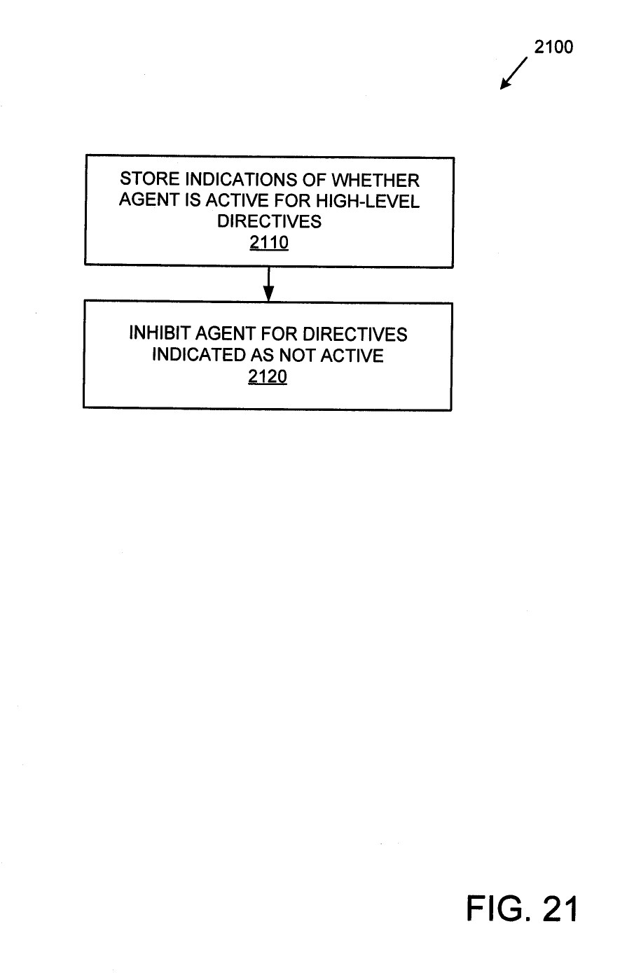

FIG. 21 is a flowchart of an exemplary method of implementing exception handler agent activation. The method 2100 can be implemented in a controller during execution of a high-level representation of a process control application (e.g., after configuring as shown in FIG. 20).

At 2110, indications of whether an agent is active (e.g., for respective high-level directives) are stored. As described herein, such active status information can be stored in a variety of ways.

At 2120, an agent is inhibited (inactivated) for directives for which the indications indicate that the agent is not active. For example, even if an exception condition is met, execution is not interrupted, and the agent is not invoked.

The method 2100 can be implemented for multiple agents. Activation can be implemented independently per high-level directive. So, for example, per-directive activation of individual agents can be achieved.

### Example 36

### Exemplary Exception Handler Agent User Interface

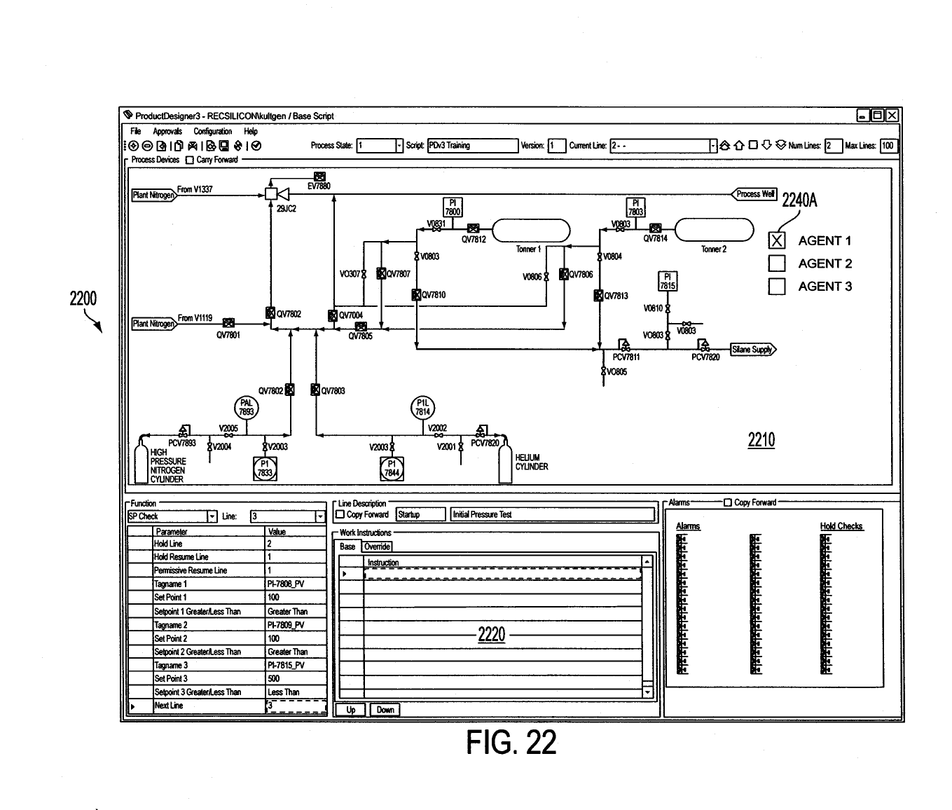

FIG. 22 is a screen shot of an exemplary user interface 2200 for receiving a user indication of whether an exception handler agent is active. The user interface 2200 can be presented by a process control application development environment. In the example, the user interface 2200 includes an area 2210 displaying a graphical representation of a machine setup for a high-level representation of a process control application (e.g., along with graphically depicted state information for field devices of the machine) and an area 2220 for configuring a currently displayed high-level directive (e.g., to provide parameters for an instruction) in the high-level representation. A displayed user interface element 2240A can be selected (e.g., clicked) by a user to indicate that an exception handler agent is active. For example, if a particular high-level directive (e.g., line 3) is currently being displayed, activating the element (e.g., checking the checkbox) indicates that the agent having the agent name displayed proximate the element 2240A (“Agent 1”) is designated as active for the high-level directive.

During execution of the represented application, the agent will be active for the high-level directive. Alternatively, the agent can also be inactivated via the user interface element 2240A (e.g., by clicking to clear the check box).

Alternatively, the agents can be depicted as devices that can be turned on or off. Color can be used to indicate the status of the respective agent (e.g., green is active, and red is inactive).

During development, whenever a high-level directive is displayed for editing, the user interface element 2240A can be updated to show the stored active status of the associated exception handler agent.

### Example 37

### Exemplary Exception Handler Agent Configuration Instruction

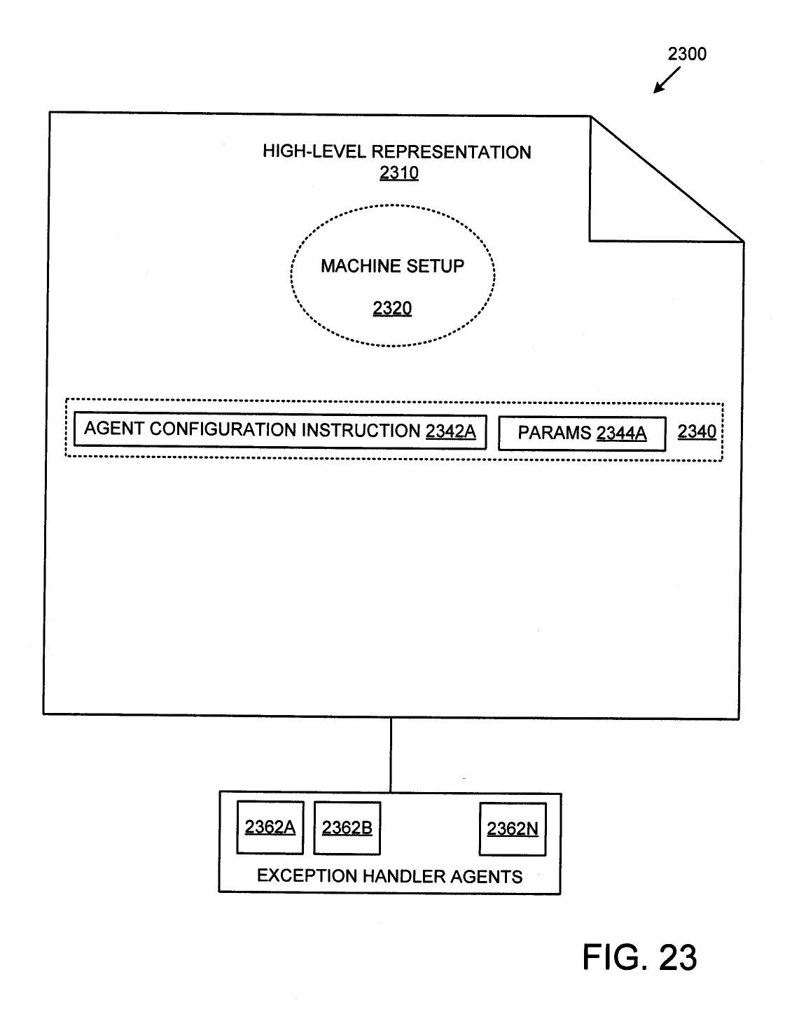

FIG. 23 is a block diagram of an exemplary system 2300 for implementing runtime exception handler agent configuration in a process control application via a high-level representation of the application. The high-level representation 2310, machine setup 2320, and agents 2362A-N can be as described for FIG. 17.

In the example, the high-level directive 2340 includes an exception handler agent configuration instruction 2342A with parameters 2344A. The parameters 2344A can specify any of the configuration information for an exception handler agent, including the identifier of the exception handler agent.

### Example 38

### Exemplary Exception Handler Agent Configuration at Runtime

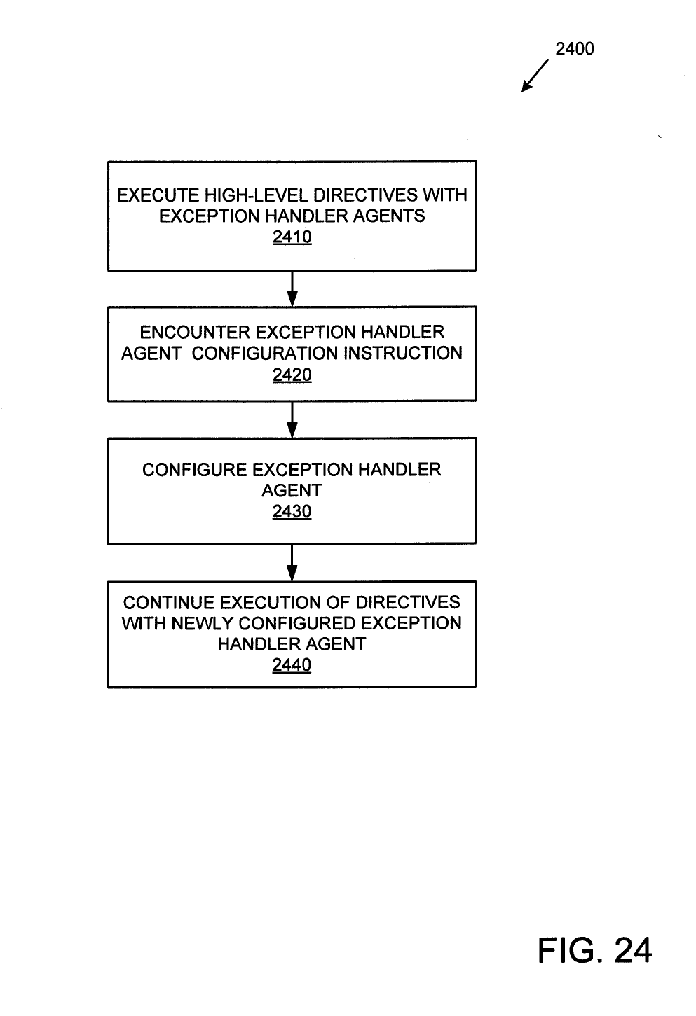

FIG. 24 is a flowchart of an exemplary method 2400 of implementing runtime exception handler agent configuration in a process control application. The method 2400 can be implemented by a controller at runtime of a high-level representation of a process control application.

At 2410, high-level directives of the application are executed, and one or more exception handler agents are active.

At 2420, an exception handler agent configuration instruction is encountered (e.g., the instruction 2342A of FIG. 23 is encountered) during runtime (e.g., by a controller executing the process control application).

At 2430, the exception handler agent indicated by the configuration instruction is configured. The agent may or may not be activated upon configuration.

At 2440, execution of the high-level directives is continued, with the newly configured exception handler agent.

### Example 39

### Exemplary Exception Handler Agent Re-Use

In any of the examples herein, an exception handler agent can be re-used. So, the agent can be re-configured during runtime of the process control application (e.g., by an interpreter in a controller). The same identifier can thus identify two different types of exception handler agents at different times during execution.

Thus, exception handler agents can be re-configured without having to engage in another download of the controller application. Such a situation can save resources, such as memory and time (e.g., to perform the download).

### Example 40

### Exemplary Advantages of Exception Handler Agents

As described herein, exception handler agents can result in technical advantages. For example, allowing an exception handler agent to be enabled or disabled per high-level directive avoids having to include logic in the high-level representation of the process control application to achieve the same result. Accordingly, memory and programmer time is saved, along with avoiding incorporating possible inadvertent errors into the application.

As described, re-using exception handler agents can save memory and time.

Also, the exception handler agents can provide functionality that effectively cannot be implemented by high-level directives alone. For example, the ability to interrupt an idle process or to prioritize exceptions would be impractical using high-level directives with the described exception handler agents. Attempts to implement such functionality would lead to lengthy, complex, and lower performance applications.

The described exception handler agents also allow easier configuration (e.g., of the upset conditions, the name of the agent, and the like).

Certain safety issues are also addressed by the agents. For example, implementing a hold type agent allows interruption of a process upon an unsafe upset condition regardless of whether another agent (e.g., a permissive) was executing. Such functionality can be used to address such unsafe upset conditions (e.g., stopping the process and alerting an operator).

### Example 41

### Exemplary Encapsulated Machine

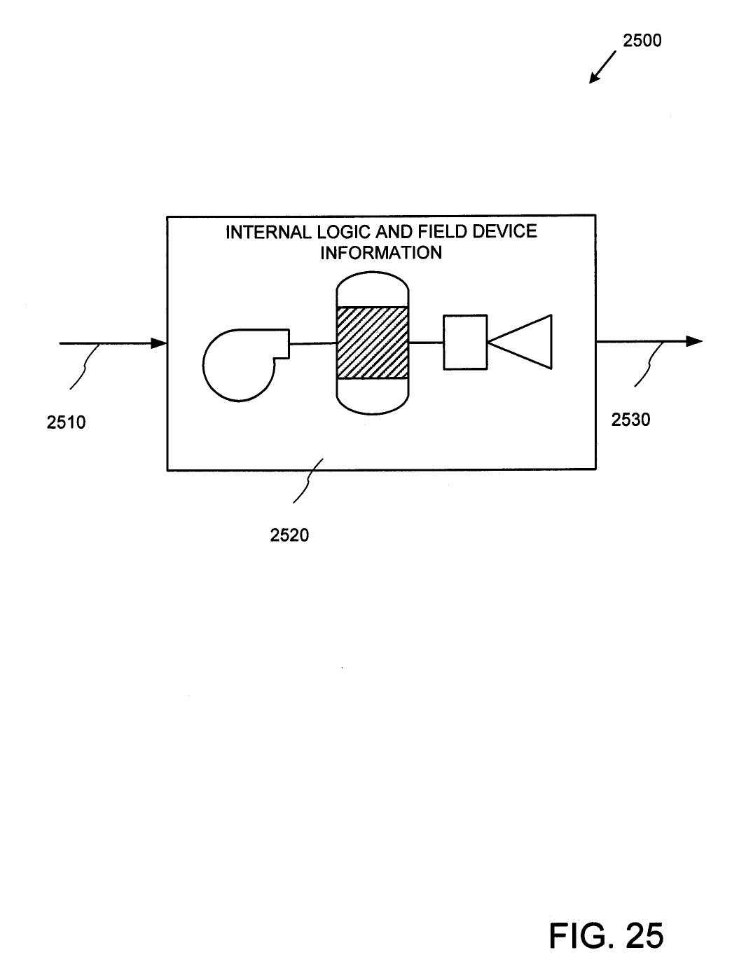

FIG. 25 is a block diagram of an exemplary encapsulated machine 2500 for a high-level representation of a process control application, which can be used in any of the examples herein. The encapsulated machine 2500 can correspond to any of the high-level representations of the process control applications described herein. The internal logic and field device information 2520 comprises the high-level directives and machine setup of the process control application. The encapsulated machine can comprise configuration information and control a plurality of field devices; however, it appears to high-level directives of other encapsulated, external machines (e.g., implemented by an external high-level representation of a process control process) machines as a single machine through which communication must be directed via supported instructions to affect internal operation of the encapsulated machine.

In addition, a communications reception socket 2510 is configured to receive messages from other encapsulated machines, and a communications transmission socket 2530 is configured to send messages to other encapsulated machines. In this way, control over field device states of an encapsulated machine can be isolated from outside interference of external high-level representations, other than through the communications sockets. Inter-high-level representation communication can be implemented via the sockets.

Configuration of the encapsulated machine 2500 can be accomplished via a process control application development environment as described herein. When executed, the functionality of the reception socket 2510 and the transmission socket 2530 can be implemented via an interpreter (e.g., executing on a controller).

High-level directives can make use of the sockets 2510 and 2530 to accomplish machine-to-machine communication via supported instructions that send messages to external machines and listen for messages from external machines. As described herein, the sockets can support respective receiving and sending of synchronization primitives.

In practice, multiple encapsulated machines can be implemented in a single controller. An encapsulated machine can be distributed over more than one single controller. However, to high-level representations of process control applications, the encapsulated machine appears to be a single machine and can be accessed via a single identifier. As described herein, the encapsulated machine can implement synchronization primitives to assist in synchronizing between multiple machines.

### Example 42

### Exemplary Instructions for Machine Synchronization

In any of the examples herein, high-level directives can include instructions that facilitate communication between encapsulated machines to achieve synchronization. For example, instructions for requesting permission to use, waiting for permission, waiting for a permission request, sending a grant of permission, and the like can be implemented in high-level directives. Such instructions can include an identifier of the encapsulated machine to which communications are sent.

### Example 43

### Exemplary Encapsulated Machine Communication

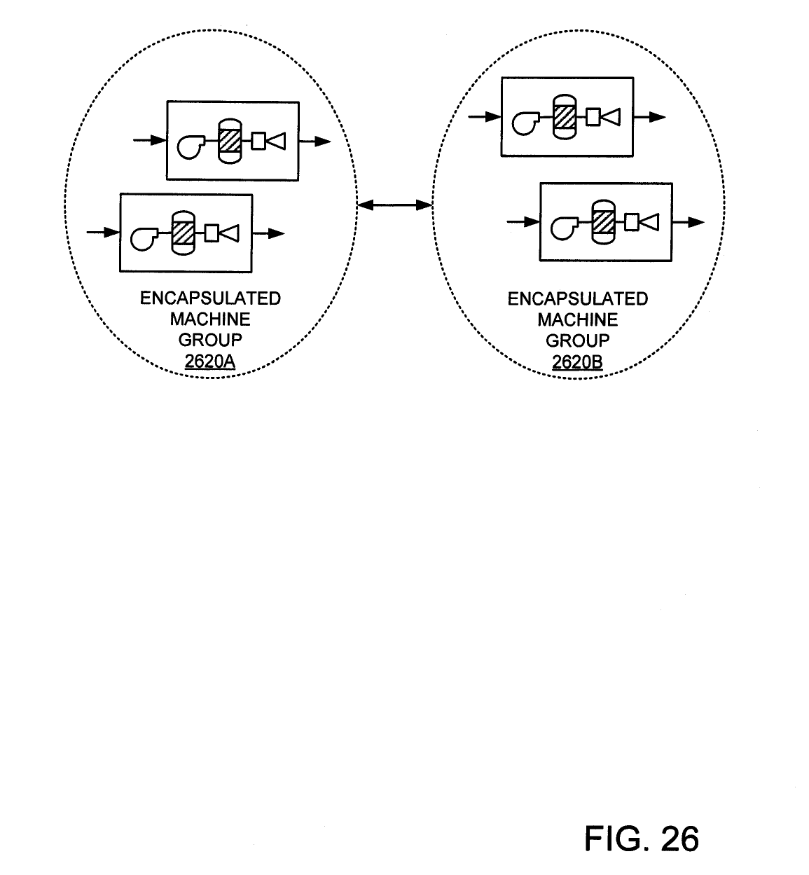

FIG. 26 is a block diagram of an exemplary system 2600 implementing multiple encapsulated machines for respective high-level representations of process control applications. In the example, one or more machines in a first group 2620A of encapsulated machines can communicate with one or more machines in a second group 2620B of encapsulated machines.

### Example 44

### Exemplary Encapsulated Machine Method

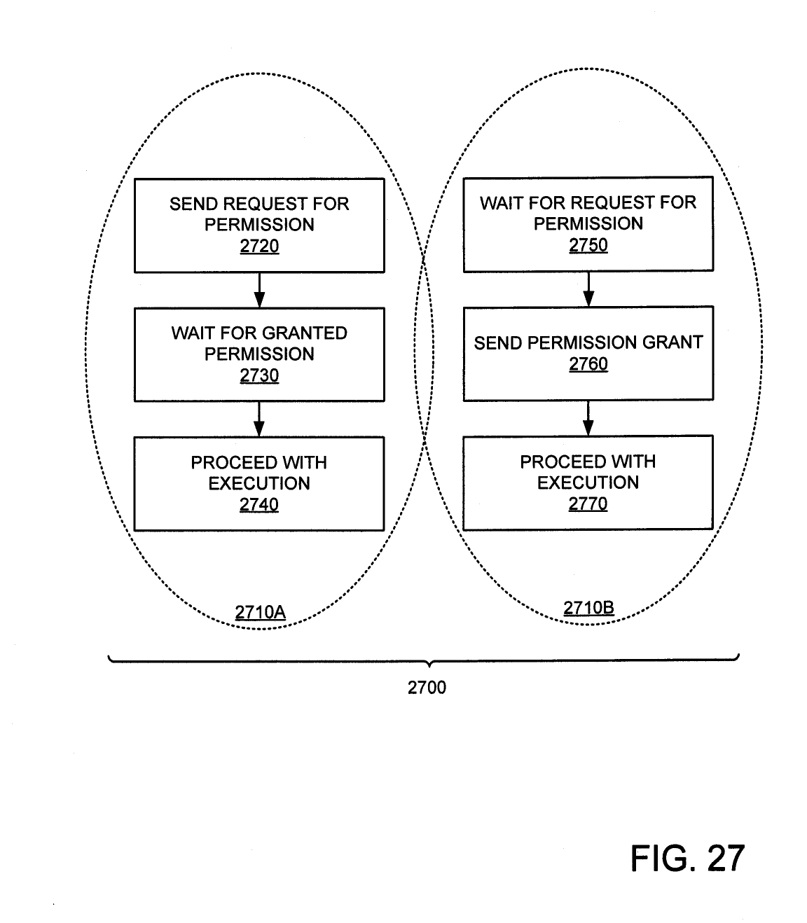

FIG. 27 is a flowchart of an exemplary method 2700 for implementing multiple encapsulated machines. In the example, the first part of the method 2710A is executed for a different encapsulated machine (e.g., responsive to interpreting a first high-level representation) than the second part of the method 2710B (e.g., which is executed responsive to interpreting a second high-level representation). The two parts can be executed in parallel, concurrently, or the like.

At 2720 a request for permission to use an external encapsulated machine is sent.

At 2730, the method waits for permission to be granted by the external encapsulated machine.

At 2740, responsive to detecting that permission is granted, execution proceeds. The detecting action is not shown explicitly because it need not be represented in the high-level representation as a directive. Instead, the detecting can be implemented at runtime via an interpreter.

At 2750, the method waits for a request for permission from an external encapsulated machine.

At 2760, responsive to detecting a request for permission, a permission grant is sent. The detecting action is not shown explicitly because it need not be represented in the high-level representation as a directive. Instead, the detecting can be implemented at runtime via an interpreter.

### Example 45

### Exemplary Encapsulated Machine Synchronization Messaging

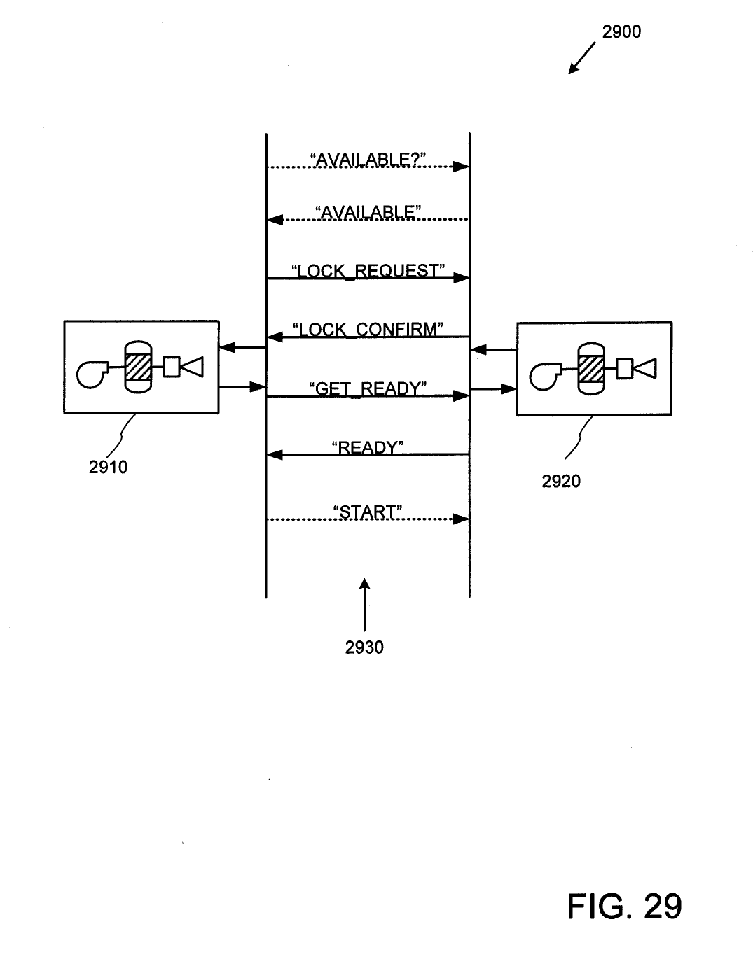

FIG. 29 is an exemplary synchronization exchange 2900 for implementing synchronization between a first encapsulated machine 2910 and a second encapsulated machine 2920. Because the first encapsulated machine requests the second encapsulated machine as a resource, the first encapsulated machine is sometimes called a “master,” and the second encapsulated machine is sometimes called a “slave.”

The synchronization exchange messages 2730 can be used to synchronize efforts between the encapsulated machines and is described in more detail below.

At 2770, execution proceeds.

In practice, the method 2700 can be performed multiple times as part of a synchronization exchange. For example, after it is determined that a machine is available, the method 2700 can first be used to acquire a lock on the machine. After the lock is acquired, the method 2700 can then be employed again to ready the machine.

### Example 46

### Exemplary Encapsulated Machine Communication Scenarios

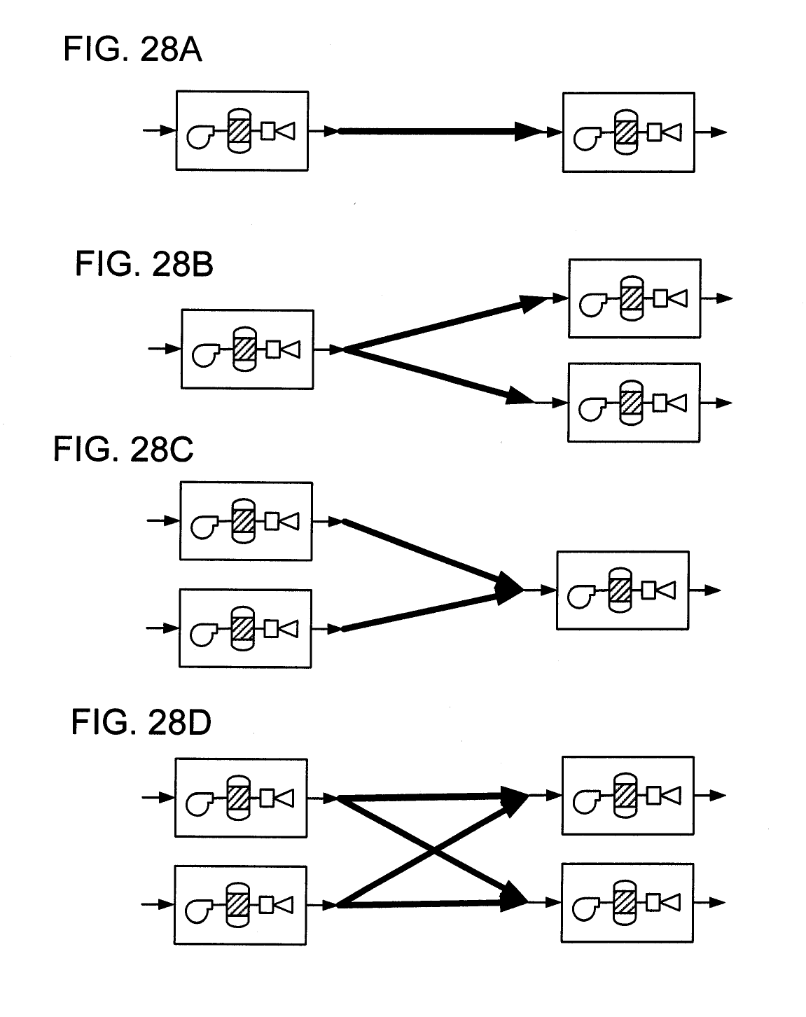

FIGS. 28A-D are illustrations of exemplary machine-to-machine communication scenarios. An exemplary single-machine-to-single-machine scenario is shown in FIG. 28A.

An exemplary single-machine-to-multiple-machine scenario is shown in FIG. 28B.

An exemplary multiple-machine-to-single-machine scenario is shown in FIG. 28C.

An exemplary multiple-machine-to-multiple-machine scenario is shown in FIG. 28D.

A developer can indicate that a high-level representation of a process control application is on one or the other end of any of the scenarios. Synchronization instructions presented during development (e.g., in a pick list of instructions) can then be limited to only those instructions that are relevant. So, for example, if a first machine (e.g., a master) is using a second machine (e.g., a slave), the first machine can list synchronization instructions for implementing a master only. It need not have the slave-related instructions (e.g., instructions related to waiting for a request to be used).

In any of the examples herein, the synchronization instructions can be used to negotiate for use of encapsulated machines (e.g., a slave machine can be used by a plurality of master machines over time).

A single overall process may involve many encapsulated machines. In order to track the scenarios of the involved machines, a two-dimensional grid can be constructed showing the machines. At the intersection of machines in the grid, a user can indicate the particular machine scenario involved (e.g., SM-SM for single-machine-to-single-machine). In many intersections, there may be no communication needed, so an appropriate identifier (e.g., “none” or “n/a”) can be used to indicate no communication. The grid can be processed by the development environment to determine which scenarios apply to which machine combinations and to present appropriate synchronization instructions as described herein.

### Example 47

### Exemplary Encapsulated Machine Synchronization Instructions Implementation

For example, in one implementation, the four following instructions can be used to achieve machine communication:

TABLE 1
Synchronization Instructions

| Name | Description | Parameters |
|---|---|---|
| Master request | Sends a request from a | Machine req (External machine) |
| | master machine to a | Request (synchronization primitive sent to slave) |
| | slave machine | |
| Master listen | At a master machine, | What slave (external machine) |
| | listens for a response | Slave response (expected synchronization |
| | from a slave machine | primitive) |
| | | Branching parameters |
| Slave response | Sends a response from | Response to Master (authorized masters) |
| | a slave machine to a | Slave response (synchronization primitive sent to |
| | master machine | master) |
| Slave listen | At a slave machine, | What master (external machine) |
| | listens for a response | Master Command (synchronization primitive |
| | from a master | expected) |
| | machine | Branching parameters |

The branching parameters can specify where execution is to proceed. For example, a parameter can specify a location (e.g., a line number in the high-level representation) where execution is to proceed when the received synchronization primitive is what was expected. Another parameter can specify a location (e.g., a line number in the high-level representation) where execution is to proceed if the synchronization primitive is high (e.g., later in the synchronization exchange than expected). Another parameter can specify where execution is to proceed if the synchronization primitive is low (e.g., earlier in the synchronization exchange than expected).

Master listen can be used in a special case of initiating communications. In the case of an available inquiry, the master listen can check to see if the slave is available without first sending a master request. On the slave side, no instructions need be implemented (e.g., the current availability status is stored in controller memory).

Primitives that are supported include available, lock_request, lock_confirm, get_ready, ready, and start. They are thus ordered from early to late in the synchronization scenario.

In the example of FIG. 27, the send request 2720 can be accomplished via a master request instruction. The wait for granted permission 2730 can be accomplished via a master listen function. The wait for request 2750 can be accomplished via a slave listen instruction, and the send permission grant 2760 can be accomplished via a slave response instruction.

### Example 48

### Exemplary Encapsulated Machine Synchronization Method

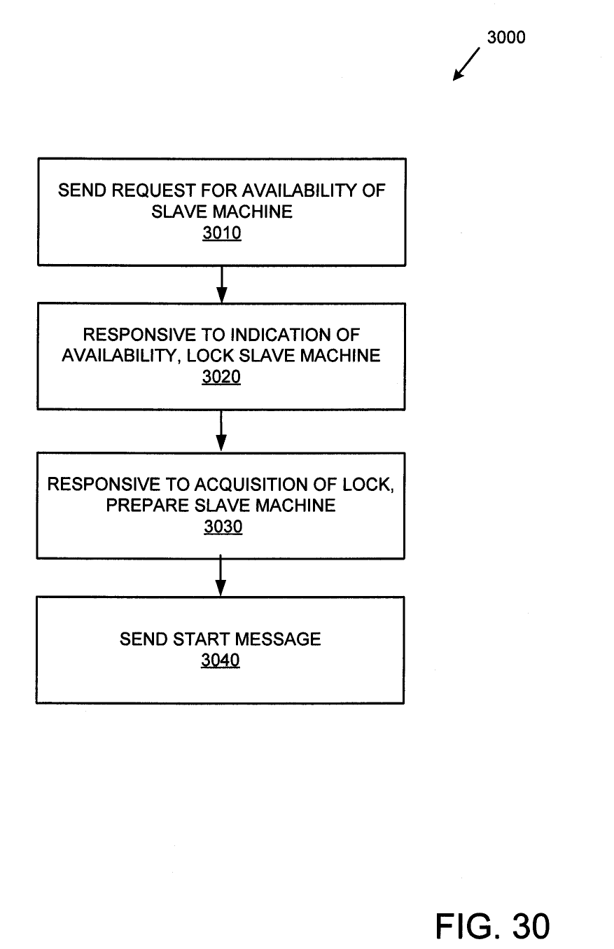

FIG. 30 is a flow chart of an exemplary method 3000 for implementing synchronization between encapsulated machines and can be used to implement the exemplary synchronization exchange 2900 of FIG. 29.

At 3010, a request is sent from a master machine to a slave machine. In practice, execution of a master listen instruction specifying the “available” primitive can accomplish the request. An “available” reply can be automatically generated by a listening agent at the slave machine (e.g., executing in an interpreter of the high-level representation) without executing a high-level directive.

At 3020, responsive to indication of availability of the slave machine, the slave machine is locked. Locking can be accomplished by execution of a master request instruction specifying the “lock_request” primitive at the master followed by execution of a master listen instruction specifying the “lock_confirm” primitive.

On the slave side, locking can be accomplished by execution of a slave listen instruction specifying the “lock_request” primitive followed by execution of a slave response instruction specifying the “lock_confirm” primitive.

At 3030, responsive to indication of acquisition of the lock, the slave machine can prepare. Preparation can be accomplished by execution of a master request instruction specifying the “get_ready” primitive at the master followed by execution of a master listen instruction specifying the “ready” primitive.

On the slave side, preparation can be accomplished by execution of a slave listen instruction specifying the “get_ready” primitive followed by execution of whatever directives are appropriate for preparation (e.g., to be used in the process control process by the requesting machine), followed by execution of a slave response instruction specifying the “ready” primitive.

Then, the master can send a start message at 3040 indicating that the process being synchronized is to start.

The instructions allow execution to be diverted if the expected primitive is not received. In such a case, a “reset” primitive can be sent to start the process over. Responsive to receiving the “reset” primitive, the slave reverts (e.g., eventually) to an available mode.

An “end” primitive can also be employed to end the process.

### Example 49

### Exemplary Available Encapsulated Machines

In any of the examples herein, there may be multiple possible slaves. The master machine can listen for the “available” synchronization primitive on successive possible slave machines until the master finds a slave that is available. Further synchronization exchange can follow as described herein.

### Example 50

### Exemplary Development Features

During development of the high-level representations of synchronized process control applications, the development environment can assist in development. For example, an encapsulated machine can be designated as a master or slave. In such a case, those instructions inappropriate for the machine can be inhibited from appearing as possible instructions at development time.

It is also possible to specify a list of possible machines with which the current machine can communicate. When selecting target machines for the instructions during development, the listed target machines can be limited to those specified as possible.

### Example 51

### Exemplary Advantages of Encapsulated Machines

In any of the examples herein, an encapsulated machine to which communication is sent can comprise a plurality of field devices but appears as a single machine with a single identifier. Such an arrangement can greatly simplify development of complex process control applications. For example, if an overall process requires a thousand field devices, it is possible, via encapsulation, the divide the field devices into encapsulated machines, forming boundaries as appropriate to facilitate communication.

Devices within the machine can work in concert to achieve a cognizable function, and other machines can use their functionality in a master-slave relationship. Because machine functionality is encapsulated, different developers can work on the different machines without regard to how the functionality is achieved within the encapsulated machine.

### Example 52

### Exemplary System for Using Multiple Device States for Instructions

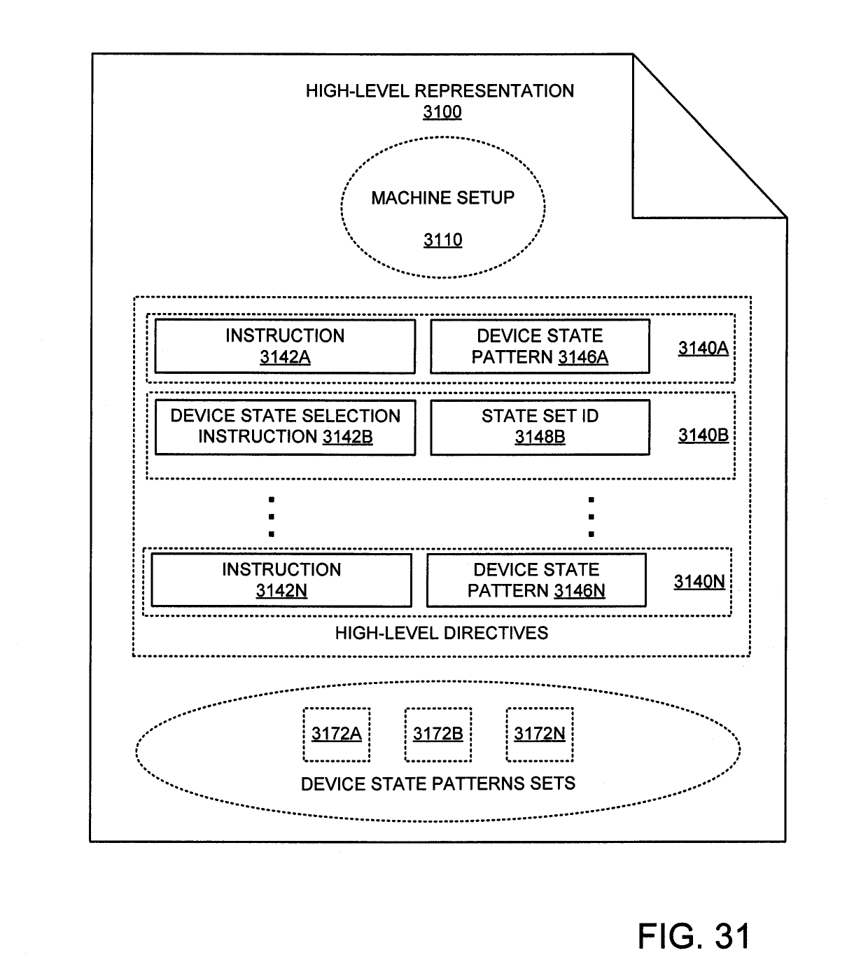

FIG. 31 is a block diagram of an exemplary system for using multiple device states for instructions 3142A-N in a high-level representation 3100 of a process control application implementing a process control process. The high-level representation can be developed via a process control application development environment such as that shown in FIG. 5. After development, the high-level representation can be downloaded and executed at runtime by an interpreter on a controller as shown herein.

In the example, the high-level representation 3100 includes high-level directives 3140A-N and field device state patterns sets 3172A-N indicating field device states for the field devices in the machine setup 3110. For the represented application, instruction 3142A is associated with device state patterns 3146A in the high-level directive 3140A.

A device state selection instruction 3142B specifying a state patterns set identifier 3148B is supported. The resulting process control application will continue to execute the directives, but the identified device state patterns set (e.g., one of the device state patterns sets 3172A-N) will be used. For example, the application can switch between device state patterns sets.

In practice, some or all of the high-level directives 3140A-N can thus be re-used (e.g., without having to copy the directives 3140A-N and applying different state patterns to them).

In addition to the pictured instructions, a directive 3140A can also include one or more parameters that are used in conjunction with the respective instruction 3142A.

### Example 53

### Exemplary Method of Using Multiple Device States

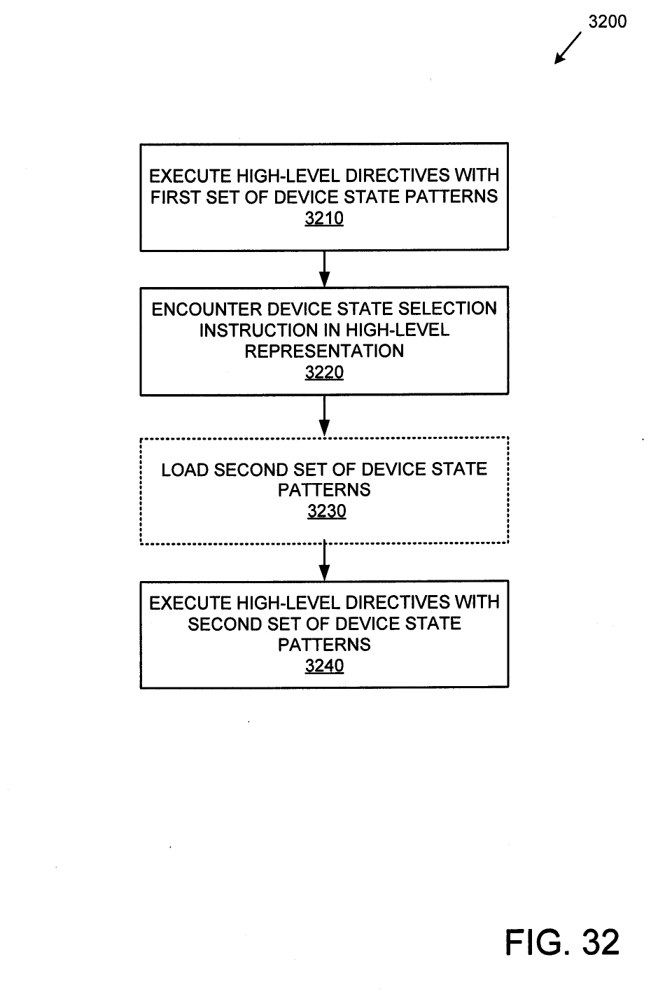

FIG. 32 is a flowchart of an exemplary method 3200 for using multiple device states for instructions in a high-level representation of a process control application.

At 3210, the high-level directives of a high-level representation of a process control application are executed (e.g., in a controller via an interpreter) for a first set of device state patterns.

At 3220, a device state selection instruction in the high-level representation is encountered. The high-level representation can specify a second set of device state patterns different from the first. For example, the device state selection instruction can include a device patterns set identifier identifying a set of field device state patterns of instructions in the high-level representation different from the state patterns set currently being used.

At 3230, a second set of device state patterns can be loaded as the current set. Such a step need not be implemented.

At 3240, execution continues. The high-level directives are executed with a second set of device state patterns. In practice, one or more instructions in the high-level representation can be re-used, but with field devices set to states as indicated in the second set of device state patterns. For example, if execution returns to a point represented in the high-level representation as a previously-encountered instruction, a different field device state pattern will be implemented.

### Example 54

### Exemplary Device Field State Patterns

In any of the examples herein, a field device state pattern can be a collection of field device states for a represented machine at a particular time during execution (e.g., for a high-level directive in a high-level representation of a process control application or at a time during execution of the process control application). For example, a field device state pattern can specify which valves are open, which pumps are running, and the like, at a point in time during execution.

### Example 55

### Exemplary System for Storing Multiple Device States

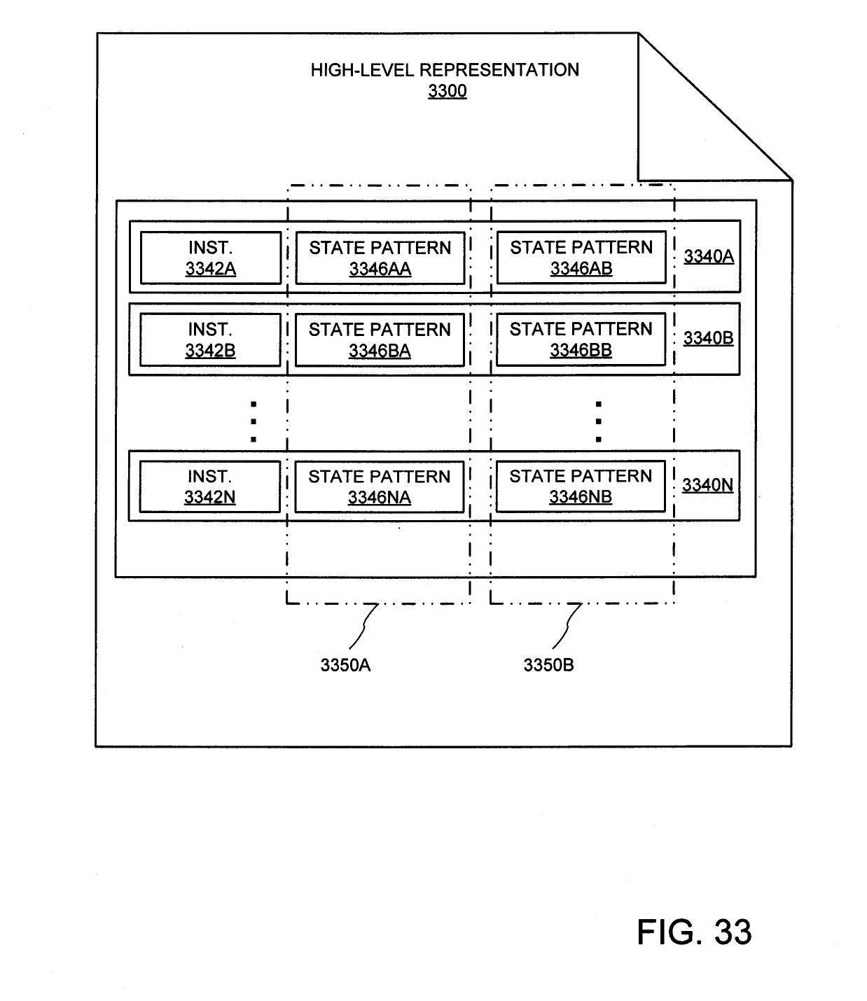

FIG. 33 is a block diagram of an exemplary system for storing multiple device state patterns for instructions in a high-level representation 3300 of a process control application.

In the example, a collection of directives (or “lines”) 3340A-N, include instructions 3342A-N. As shown, a single instruction 3342A can be associated with more than one device state pattern 3346AA, 3346AB. In this way, the instruction 3342A can be re-used in the high-level representation 3300. For example, a first time the instruction 3342A is executed, the field devices can be set to the device state pattern 3346AA. At a subsequent time during execution, the same instruction 3342A can be executed with the field devices set to the device state pattern 3346AB. Still further device state patterns can be used.

In any of the examples herein, selection of a field device state patterns set can include a plurality of device state patterns (e.g., 3346AA-3346NA), where an individual pattern specifies states for the field devices in a machine associated with the high-level representation of the process control application.

### Example 56

### Multiple Device States during Development

In any of the examples herein, the field device state patterns can be shown in a visual representation of a machine associated with a high-level representation of a process control application during development of the application. Device state selection instructions can also be implemented in a mock execution of the high-level representation of the application during development.

A developer can insert the device state selection instruction and indicate the device state patterns set identifier via a user interface (e.g., a drop down menu of choices).

### Example 57

### Exemplary Advantages of Multiple Device States

Using the multiple device states techniques described herein can result in certain advantages. For example, allowing re-use of instructions can reduce the amount of work, memory, and other resources for developing process control applications. Errors can also be avoided.

Support of a state selection instruction can avoid copying instructions and applying different state patterns to them. The memory and effort involved can thus be reduced, and an opportunity for introducing error (e.g., during the copying) can also be avoided.

### Example 58

### Exemplary Simulation

For any of the examples described herein, a simulation mode can be implemented in the process control application development environment. So, for example, instead of downloading an application to a controller and executing it there, execution can be simulated in the development environment. Because simulation steps through the high-level directives in a playback-like mode, it is sometimes called “VCR mode.”

A user-configurable time delay between high-level directives can be set (e.g., in seconds or fractions thereof). A user can then watch simulated execution, during which field device states can be indicated on the user interface.

Exception handler agents, machine communication scenarios, and multiple states can be implemented during simulation. In such a case, rather than the controller performing the described methods, the development environment can perform them.

### Example 59

### Exemplary Controller

For any of the examples herein, a controller can be any specialized electronic device that can monitor and affect the operational conditions of a dynamic system (e.g., to implement a process control process). As described herein, controllers from a wide variety of vendors can be implemented. An interpreter can be executed at a controller to interpret high-level directives in a high-level representation of a process control process.

### Example 60

### Exemplary Computing Environment

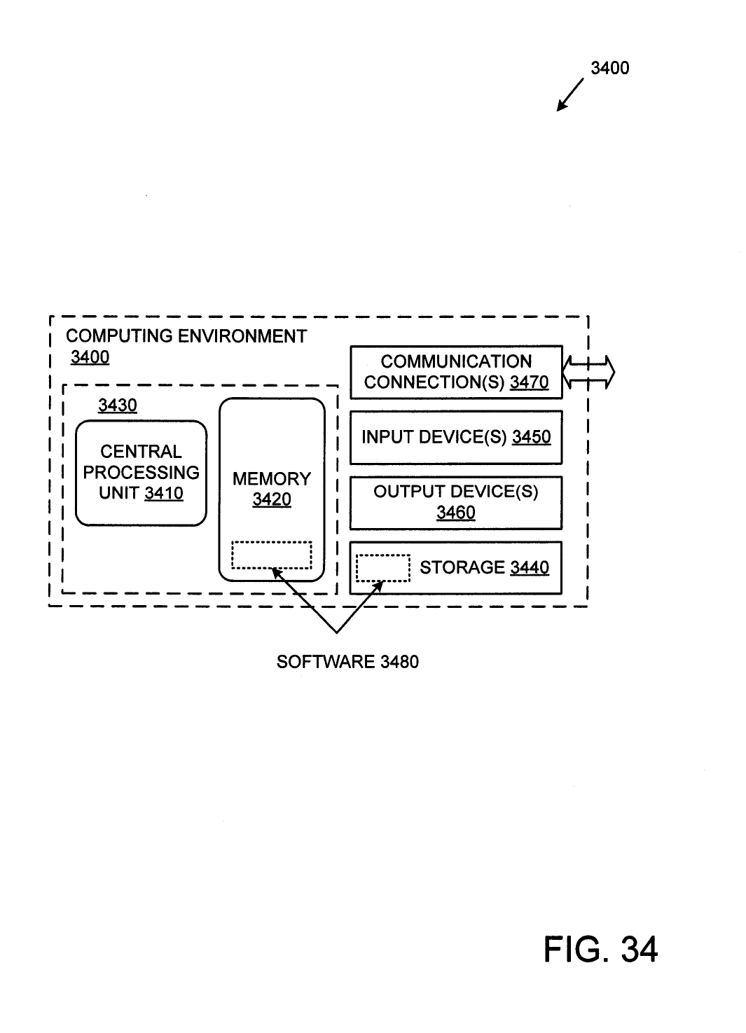

FIG. 34 illustrates a generalized example of a suitable computing environment 3400 in which the described techniques can be implemented. The computing environment 3400 is not intended to suggest any limitation as to scope of use or functionality, as the technologies may be implemented in diverse general-purpose or special-purpose computing environments. A computing environment can be implemented in a controller. For example, a controller or controller system can be used to store and execute the methods described herein, implement the systems described herein, store the data structures described herein, or combinations thereof.

With reference to FIG. 34, the computing environment 3400 includes at least one processing unit 3410 and memory 3420 (e.g., coupled to the at least one processing unit 3410). In FIG. 34, this basic configuration 3430 is included within a dashed line. The processing unit 3410 executes computer-executable instructions and may be a real or a virtual processor. In a multi-processing system, multiple processing units execute computer-executable instructions to increase processing power. The memory 3420 may be volatile memory (e.g., registers, cache, RAM), non-volatile memory (e.g., ROM, EEPROM, flash memory, etc.), or some combination of the two. The memory 3420 can store software 3480 implementing any of the technologies described herein (e.g., storing computer-executable instructions for performing any of the methods described herein).

A computing environment may have additional features. For example, the computing environment 3400 includes storage 3440, one or more input devices 3450, one or more output devices 3460, and one or more communication connections 3470. An interconnection mechanism (not shown) such as a bus, controller, or network interconnects the components of the computing environment 3400. Typically, operating system software (not shown) provides an operating environment for other software executing in the computing environment 3400, and coordinates activities of the components of the computing environment 3400.

The storage 3440 may be removable or non-removable, and includes magnetic disks, magnetic tapes or cassettes, CD-ROMs, CD-RWs, DVDs, flash memory, or any other computer-readable media which can be used to store information and which can be accessed within the computing environment 3400. The storage 3440 can store software 3480 containing instructions for any of the technologies described herein.

The input device(s) 3450 may be a touch input device such as a keyboard, mouse, pen, or trackball, a voice input device, a scanning device, or another device that provides input to the computing environment 3400. For audio, the input device(s) 3450 may be a sound card or similar device that accepts audio input in analog or digital form, or a CD-ROM reader that provides audio samples to the computing environment. The output device(s) 3460 may be a display, printer, speaker, CD-writer, or another device that provides output from the computing environment 3400.

The communication connection(s) 3470 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor (e.g., which is implemented via a real processor). Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Methods in Computer-Readable Media

Any of the methods described herein can be implemented by computer-executable instructions in one or more computer-readable media (e.g., computer-readable storage media or other tangible media). The technologies described herein can be implemented in a variety of programming languages.

### Exemplary Computer Program Product

In any of the examples herein, methods can be embodied in a computer program product. For example, a physical computer-readable medium storing computer-executable instructions performing any of the methods described herein can be offered as a product for use in a computing environment, such as a personal computer, controller, or the like.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

1. A computer-implemented method comprising:
in a controller, executing, via interpretation, a high-level representation of a process control application implementing a process control process, wherein the high-level representation comprises an exception handler agent comprising an exception handler type and an exception condition; and
upon detection that the exception condition is satisfied:
(a) interrupting execution of the process control application;
(b) invoking the exception handler agent according to the exception handler type of the exception handler agent; and
(c) resuming execution of the process control application.

2. One or more computer-readable storage media having stored thereon computer-executable instructions for performing the method of claim 1.

3. The computer-implemented method of claim 1 wherein:
the high-level representation of the process control application comprises a plurality of high-level directives; and
the method further comprises:
storing indications indicative of whether the exception handler agent is active for respective of the high-level directives; and
inhibiting the exception handler agent for those high-level directives for which the indications indicate that the exception handler is not active.

4. The computer-implemented method of claim 3 further comprising:
during development of the process control application, receiving a user action indicative of whether the exception handler agent is active for a particular high-level directive of the process control application; and
responsive to the user action, storing an indication indicative of whether the exception handler agent is active for the particular high-level directive as associated with the particular high-level directive.

5. The computer-implemented method of claim 4 wherein the user action comprises clicking on a user interface element representing the exception handler agent.

6. The computer-implemented method of claim 5 wherein the user interface element representing the exception handler agent is one of a plurality of icons representing respective exception handler agents.

7. The computer-implemented method of claim 1 further comprising:
after resuming execution of the process control application, encountering an exception handler agent configuration instruction comprising an exception handler type and an exception condition;
responsive to encountering the exception handler agent configuration instruction, re-configuring the exception handler agent according to the exception handler agent configuration instruction.

8. A system comprising:
one or more processors;
memory coupled to the one or more processors;
a stored high-level representation of a process control application;
stored configuration information for a plurality of exception handler agents, wherein the exception handler agents comprise respective exception handler types and exception conditions.

9. The system of claim 8 wherein:
the stored high-level representation of the process control application comprises a plurality of high-level directives; and
the system further comprises stored indications of whether the exception handler agents are active for respective of the high-level directives.

10. The system of claim 9 further comprising:
an interpreter configured to execute the stored high-level representation and further configured to activate the exception handler agents when executing high-level directives as indicated by the stored indications.

11. A computer-implemented method of synchronizing action between a first encapsulated machine implemented via execution of a first high-level representation of a first process control application and a second encapsulated machine implemented via execution of a second high-level representation of a second process control application, the method comprising:
in the first encapsulated machine, performing (a)-(c) responsive to execution of the first high-level representation of the first process control application:
(a) sending a request for permission to an external, encapsulated machine;
(b) waiting for the request to be granted;
(c) responsive to detection that the request has been granted, proceeding with execution after the request is granted;
in the second encapsulated machine, performing (d)-(f) responsive to execution of the second high-level representation of the second process control application:
(d) waiting for a request for permission from an external, encapsulated machine;
(e) responsive to detection that a request has been received, sending grant of permission to the external, encapsulated machine;
(f) proceeding with execution after sending the grant.

12. One or more computer-readable storage media having stored thereon computer-executable instructions for performing the computer-implemented method of claim 11.

13. The computer-implemented method of claim 14 wherein:
the first encapsulated machine executes master functionality; and
the second encapsulated machine executes slave functionality.

14. The computer-implemented method of claim 11 further comprising:
before sending the request for permission, checking a plurality of encapsulated machines for availability via a synchronization primitive.

15. The computer-implemented method of claim 14 wherein:
the first encapsulated machine checks availability via execution of a high-level directive in the first high-level representation; and
the second encapsulated machine indicates it is available via an agent executing in an interpreter of the second high-level representation.

16. The computer-implemented method of claim 15 wherein:
the second encapsulated machine indicates it is available without executing a high-level directive.

17. The computer-implemented method of claim 11 wherein:
the second encapsulated machine comprises a plurality of field devices but appears to the first encapsulated machine as a single machine with a single identifier.

18. The computer-implemented method of claim 11 wherein:
sending the request for permission comprises sending a get_ready synchronization primitive; and
sending grant of permission comprises sending a ready synchronization primitive after preparing at the second encapsulated machine to be used by the first encapsulated machine in a process control process.

19. The computer-implemented method of claim 11 wherein:
sending the request for permission comprises executing a master request instruction; and
waiting for the request to be granted comprises executing a master listen instruction, wherein the master listen instruction comprises a parameter indicating a location in the first high-level representation to which execution is to proceed if a synchronization primitive later in a synchronization exchange than expected is received.

20. A system comprising:
a controller comprising memory;
an interpreter executing, in memory of the controller, and supporting synchronization primitives comprising available, lock_request, lock_confirm, get_ready, ready, and start.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)
